(19) United States
(12) Patent Application Publication
(10) Pub. No.: US 2024/0403749 A1
(43) Pub. Date: Dec. 5, 2024

(54) MANAGING LOCATION-BASED TASKS WITH A LOCATION-AWARE VEHICLE

(71) Applicant: Polaris Industries Inc., Medina, MN (US)

(72) Inventors: Jacob Larson, Golden Valley, MN (US); Joseph Paul Nuxoll, San Jose, CA (US); Christopher Michael Huntress, Andover, MN (US); Elaine Michelle Scott, Bigfork, MT (US); Lester Lee, Castro Valley, CA (US)

(21) Appl. No.: 18/678,149

(22) Filed: May 30, 2024

Related U.S. Application Data
(60) Provisional application No. 63/470,011, filed on May 31, 2023.

(51) Int. Cl. G06Q 10/0631

(52) U.S. Cl. CPC G06Q 10/06311

(57) ABSTRACT

A method for managing location-based tasks for a location-aware vehicle, including: receiving a first request from a first device having a first user interface to create a first location-based task; creating a first location-based task based on the input received from the first device; storing the first location-based task in a task-service memory; associating the first location-based task with a first location; and associating the location-based task with the location-aware vehicle.

### CROSS REFERENCE TO RELATED APPLICATIONS

This application claims the benefit of U.S. Provisional Patent Application No. 63/470,011 filed May 31, 2023 entitled MANAGING LOCATION-BASED TASKS WITH A LOCATION-AWARE VEHICLE, the contents of which are expressly incorporated herein by reference.

### BACKGROUND

Systems and methods for organizing and managing a person's tasks, such as assigned work items, chores, or other laborious duties or activities are well known. Such systems and methods help persons and entities organize and monitor tasks by providing calendars of tasks due, noting task assignments to persons, tracking task statuses and completions, and so on. Such traditional task management systems focus on the human users of the systems, which may be appropriate in certain traditional work environments, but may not be so helpful in vehicle-centric work environments.

### SUMMARY

Embodiments of the present disclosure include a number of systems, devices and methods for managing and completing location-specific tasks with location-aware vehicles.

One embodiment is a method for managing location-based tasks for a location-aware vehicle. The method comprises: receiving a first request from a first device having a first user interface to create a first location-based task; creating a first location-based task based on the input received from the first device; storing the first location-based task in a task-service memory; associating the first location-based task with a first location; and associating the location-based task with the location-aware vehicle.

Another embodiment is a method of creating a location-based task for a location-aware vehicle, the method comprising: receiving a request from a device having a user interface to create a location-based task; identifying the task location of the location-based task for the location-aware vehicle; determining task content of the location-based task, including the task location and one or more of a task name, task category, task materials, task work group, vehicle operator, and vehicle identification; and assigning the location-based task to the location-aware vehicle.

Yet another embodiment is a method of creating a work list from a plurality of location-based tasks, the method comprising: defining a plurality of location-based tasks, each location-based task associated with a predefined location and including predefined task content, including one or more task content items of a task name, task location, task category, task materials, task workgroup, vehicle operator, and vehicle identification; displaying all or a portion of the plurality of location-based tasks on a display of a user interface of a location-aware vehicle or a remote computing device; displaying a list of available task filters on the display of the user interface; transmitting a request from the user interface to a task-service processor identifying selection of the task filters; and defining a work list using the task-service processor, the work list including less than all of the defined plurality of location-based tasks based on the selection of the task filters.

Another embodiment is a method of managing a plurality of location-based tasks for a plurality of location-aware vehicles, the method comprising: defining the plurality of location-based tasks, including a first task having first task content and a second task having second task content; associating each of the plurality of location-based tasks with a task location, including associating the first location-based task with a first task location, and associating a second location-based task with a second task location; identifying the plurality of location-aware vehicles, including identifying a first location-aware vehicle and a second location-aware vehicle, the first location-aware vehicle configured to determine a vehicle location of the first location-aware vehicle and the second location-aware vehicle configured to determine a vehicle location of the second location-aware vehicle; communicating a first location-based task to the first location-aware vehicle; and communicating a second location-based task to the second location-aware vehicle.

Another embodiment is a method that comprises: defining a plurality of location-based tasks, including a first set of tasks and a second set of tasks; associating the plurality of location-based tasks with a plurality of unique locations, including associating a first set of location-based tasks with a first set of unique locations and associating a second set of task with a second set of unique locations; communicating the plurality of tasks and associated unique locations to a location-aware vehicle; displaying a graphical map of a location area that includes a first location of the location-aware vehicle, graphical representations of the first set of location-based tasks, and the first set of associated unique locations; and changing a display of the graphical map to display a second location of the location-aware vehicle, graphical indicators of the second set of tasks and the second set of associated unique locations, in response to the location-aware vehicle moving from the first location to the second location.

In addition to methods, embodiments include an off-road utility vehicle for managing location-based tasks. In one such embodiment, the vehicle comprises: a vehicle frame connected to a plurality of ground-engaging members; a vehicle prime mover coupled to the vehicle frame; a vehicle controller including configured to control vehicle operating systems, including the vehicle prime mover; a geolocation system in communication with the vehicle controller and configured to determine a location of the off-road utility vehicle; a network interface in communication with the vehicle controller and configured to communicate to remote computing devices; a user interface in communication with the vehicle controller, the user interface including a display device, and an input device configured to receive data relating to the location-based task, including a location of the location-based task; and a task-service processor configured to communicate with the vehicle controller, the task-service processor configured to: receive the location of the off-road utility vehicle from the geolocation system;
receive the data relating to the location-based task; and manage the location-based tasks based on the location of the off-road utility vehicle, and the data relating to the location-based task, including creating a location-based task list to be displayed on the display device of the user interface.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The disclosure can be understood in consideration of the following detailed description of various embodiments in connection with the accompanying drawings, in which:

FIG. 1 is a perspective view of a vehicle, according to an embodiment of the present disclosure;

FIG. 2 is a block diagram of a vehicle system with location-based task management capabilities, according to an embodiment of the present disclosure;

FIG. 3 is a block diagram of a system for managing location-based tasks, according to an embodiment of the present disclosure;

FIG. 4 is a flow chart depicting and describing a method of 200 for managing location-based tasks for a location-aware vehicle, according to an embodiment of the present disclosure;

FIGS. 5A to 5C depict task-management-access GUIs displayed on a remote-computing device, according to embodiments of the disclosure;

FIGS. 6A to 6C depict task-management-access GUIs displayed on a mobile computing device, according to embodiments of the disclosure;

FIG. 7 depicts a task-management-access GUI displayed on a remote computing device, according to an embodiment of the present disclosure;

FIG. 8 is a flow chart depicting a method for creating a location-based task for a location-aware vehicle, according to an embodiment of the present disclosure;

FIG. 9 depicts a series of GUIs illustrating an embodiment of the method of FIG. 8, according to an embodiment of the present disclosure;

FIGS. 10-15 depict GUIs displayed on a mobile computing device, and displaying features relating to creation and display location-based tasks, according to embodiments of the disclosure;

FIGS. 16-17 depict GUIs for assigning a user to a location-based task, according to embodiments of the disclosure;

FIGS. 18-20 depict GUIs for associating materials with a location-based task, according to embodiments of the disclosure;

FIGS. 21-26 depict GUIs for associating locations with a location-based task, according to embodiments of the disclosure;

FIGS. 27-29 depict GUIs illustrating features relating to location-based task templates, according to embodiments of the disclosure;

FIG. 30 is a flow chart depicting a method of creating a work list from a plurality of location-based tasks, according to an embodiment of the present disclosure;

FIG. 31 depicts a GUI displaying available work lists, according to an embodiment of the present disclosure;

FIG. 32 depicts a GUI displaying location-based task near a user, according to an embodiment of the present disclosure;

FIG. 33 is a flow diagram comprising a series of GUIs for creating a location-based task work list, according to an embodiment of the present disclosure;

FIGS. 34-38 depict GUIs illustrating the use of mapping for managing location-based tasks, according to embodiments of the disclosure;

FIGS. 39-40 depict GUIs for marking tasks complete from a displayed map, according to embodiments of the disclosure;

FIGS. 41-48 depict GUIs illustrating features for managing assignments, users and work groups, according to embodiments of the disclosure;

FIGS. 49-51 depict GUIs illustrating notification features, according to embodiments of the disclosure;

FIG. 52 depicts a vehicle GUI displaying a list of unfiltered tasks, according to an embodiment of the present disclosure;

FIG. 53 depicts a vehicle new task GUI displaying a pop-up menu with a list of categories for creating a new task, as well as a map for adding a location to the new task, according to an embodiment of the present disclosure'

FIG. 54 depicts a vehicle GUI displaying a fillable list of task content for the new task of FIG. 53, according to an embodiment of the present disclosure;

FIG. 55 depicts a vehicle GUI displaying a draggable map with a task indicator marking a location associated with a task, according to an embodiment of the present disclosure;

FIG. 56 depicts a vehicle GUI 538 displaying a map with first and second tasks having associated locations, according to an embodiment of the present disclosure;

FIG. 57 depicts a vehicle GUI displaying a list of task locations, according to an embodiment of the present disclosure;

FIG. 58 depicts a vehicle GUI displaying a fillable list of task content for a new task, according to an embodiment of the present disclosure;

FIG. 59 depicts a vehicle GUI displaying a list of people/users assigned to a particular task, according to an embodiment of the present disclosure;

FIG. 60 depicts a vehicle GUI displaying a material list associated with a farming task, according to an embodiment of the present disclosure;

FIG. 61 depicts a vehicle GUI displaying a task list filtered by a task category, according to an embodiment of the present disclosure;

FIG. 62 depicts a vehicle GUI displaying an unfiltered task list, according to an embodiment of the present disclosure;

FIG. 63 depicts a vehicle GUI displaying a plurality of work list icons, according to an embodiment of the present disclosure;

FIG. 64 depicts a vehicle GUI for creating a work list based on categories, according to an embodiment of the present disclosure;

FIG. 65 depicts a vehicle GUI displaying available options for filtering tasks, according to an embodiment of the present disclosure;

FIG. 66 depicts another vehicle GUI displaying available options for filtering tasks, according to an embodiment of the present disclosure;

FIG. 67 depicts a vehicle GUI 560 displaying a map associated with a location that is a place corresponding to a geographical area, according to an embodiment of the present disclosure;

FIG. 68 depicts a vehicle GUI displaying a list of categories, according to an embodiment of the present disclosure;

FIG. 69 depicts a vehicle GUI displaying a task name, task completion status, and due date, according to an embodiment of the present disclosure;

FIG. 70 depicts a vehicle GUI displaying details of a selected task, according to an embodiment of the present disclosure, according to an embodiment of the present disclosure;

FIG. 71 depicts a portion of a vehicle GUI of a location on a map, as well as a GUI which is displayed in response to a task displayed being selected by a user, according to an embodiment of the present disclosure;

FIG. 72 depicts a vehicle GUI 572 displaying a task name and content, along with the map with location, in a split-screen format, according to an embodiment of the present disclosure;

FIG. 73 depicts a vehicle GUI displaying a screen for creating a new task, with fillable areas for receiving user input relating to task content, according to an embodiment of the present disclosure;

FIG. 74 depicts a GUI displaying materials associated with a selected task category, according to an embodiment of the present disclosure;

FIG. 75 depicts a portion of a vehicle GUI displaying a search feature relating to the materials of a task, according to an embodiment of the present disclosure;

FIG. 76 depicts a remote-computing device GUI displaying a list of unfiltered tasks, according to an embodiment of the present disclosure;

FIG. 77 depicts a remote-computing device GUI 594 which may be used to edit a task, according to an embodiment of the present disclosure;

FIG. 78 depicts a remote-computing device GUI displaying a task list, according to an embodiment of the present disclosure;

FIG. 79 depicts a remote-computing device GUI displaying a task list, with a first task being selected for completion, according to an embodiment of the present disclosure;

FIG. 80 depicts a remote-computing device GUI displaying a task list, and also a pop-up menu resulting from a “status” filter request being made by a user, according to an embodiment of the present disclosure;

FIG. 81 depicts a remote-computing device GUI displaying a solid circle and check mark next to one task, thereby indicating that the indicated task is complete, according to an embodiment of the present disclosure;

FIG. 82 depicts a remote-computing device GUI displaying another embodiment of a task list, according to an embodiment of the present disclosure;

FIG. 83 depicts a remote-computing device GUI displaying a list of selectable task categories for creating a new task, according to an embodiment of the present disclosure;

FIG. 84 depicts a remote-computing device GUI displaying options for defining a new task, according to an embodiment of the present disclosure;

FIG. 85 depicts a remote-computing device GUI for assigning a new task to a person selected from a displayed list, according to an embodiment of the present disclosure;

FIG. 86 depicts a remote-computing device GUI for associating a location with a task, according to an embodiment of the present disclosure;

FIG. 87 depicts a remote-computing device GUI for adding materials to a task, according to an embodiment of the present disclosure;

FIG. 88 depicts a remote-computing device GUI displaying graphics for adding a new task, according to an embodiment of the present disclosure;

FIG. 89 depicts a remote-computing device GUI displaying options for adding a location that is a field track, according to an embodiment of the present disclosure;

FIG. 90 depicts a remote-computing device GUI displaying work lists, according to an embodiment of the present disclosure;

FIG. 91 depicts a remote-computing device GUI displaying assignments by work groups, vehicles and people, according to an embodiment of the present disclosure;

FIG. 92 depicts a remote-computing device GUI displaying a filtered list of tasks, according to an embodiment of the present disclosure;

FIG. 93 depicts a remote-computing device GUI displaying a list or set of icons of vehicles and people, according to an embodiment of the present disclosure;

FIG. 94 depicts a remote-computing device GUI for managing people, according to an embodiment of the present disclosure;

FIG. 95 depicts a remote-computing device GUI displaying an explanation of work group formation for a user, as part of the assignment functionality, according to an embodiment of the present disclosure;

FIG. 96 depicts an assignment remote-computing device GUI that lists people and vehicles associated with a selected work group, according to an embodiment of the present disclosure;

FIG. 97 depicts a remote-computing device GUI displaying an add-people function for adding a person or user to a work group, according to an embodiment of the present disclosure;

FIG. 98 depicts a remote-computing device GUI displaying an add-vehicle function for adding a vehicle to a work group, according to an embodiment of the present disclosure;

FIG. 99 depicts a remote-computing device GUI displaying a list of tasks with a plurality of filter buttons, according to an embodiment of the present disclosure; and

FIG. 100 depicts a remote-computing device GUI displaying additional filters, such as due date, status, materials and “group by,” according to an embodiment of the present disclosure

### DETAILED DESCRIPTION

For the purposes of understanding the disclosure, reference will now be made to the embodiments illustrated in the drawings, which are described below. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all combinations, modifications, equivalents, and alternatives falling within the spirit and scope of the invention as defined by the appended claims.

While the present disclosure primarily relates to off-road utility vehicles, it should be understood, however, that the invention may have application to other types of vehicles that may share in the function of accomplishing a task, i.e., have some “utility”, such as providing transportation to a work site and in some cases directly assisting in accomplishing the task. Such utility vehicles may include side-by-side utility vehicles, all-terrain vehicles (ATVs), motorcycles, snowmobiles, and other types of off-road recreational vehicles.

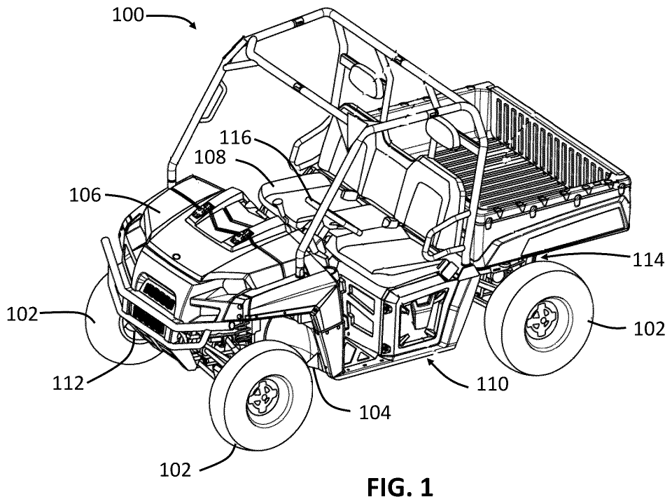

Referring to FIG. 1, an embodiment of utility vehicle 100 is depicted. In an embodiment, utility vehicle 100 includes ground-engaging members 102, frame 104, body portions 106, scats 108, prime mover (engine) 110, along with various operating systems, such as transmission system 112, braking system 114, steering system 116, and so on.

Ground-engaging members 102 may include a one or more wheels, tracks, including endless tracks, skis or other suitable devices which support vehicle 100 relative to the ground, Frame 104 is supported by the ground-engaging members and provides support to various other components and systems of utility vehicle 100. Body portions 106 may be connected to portions of frame 104, providing protection to a driver and passenger of utility vehicle 100. Seats 108 are directly or indirectly connected to frame 104 and provide support for the driver and passenger(s) of utility vehicle 100.

Prime mover 110 may comprise an internal-combustion engine, electric motor, electric-combustion hybrid motor, or similar, for powering utility vehicle 100. Transmission system 112 is coupled to prime mover 110 and ground-engaging members 102, and may include a shiftable transmission, continuously variable transmission (CVT), electrical variable transmission (EVT), e-CVT, and so on, depending on the type of prime mover and vehicle.

Braking system 112 provides a braking function for utility vehicle 100 and is coupled to one or more ground engaging members 102, and in some embodiments, to prime mover 110 and/or transmission system 112.

Steering system 116 is coupled to one or more ground-engaging members 102, such as front wheels 102, as depicted. Steering system 116 may also include a graspable steering device, such as a steering wheel.

Further details and embodiments of known utility vehicles are depicted and described in U.S. Pat. No. 10,166,836, issued Jan. 1, 2019, entitled “Utility Vehicle,” and assigned to Polaris Industries, Inc., and U.S. Patent Pub. No. 2020/0198561 A1, published Jun. 25, 2020, entitled Managing Recreational Vehicles and Accessories, and assigned to Polaris Industries, Inc., both of which are incorporated herein by reference in their entireties.

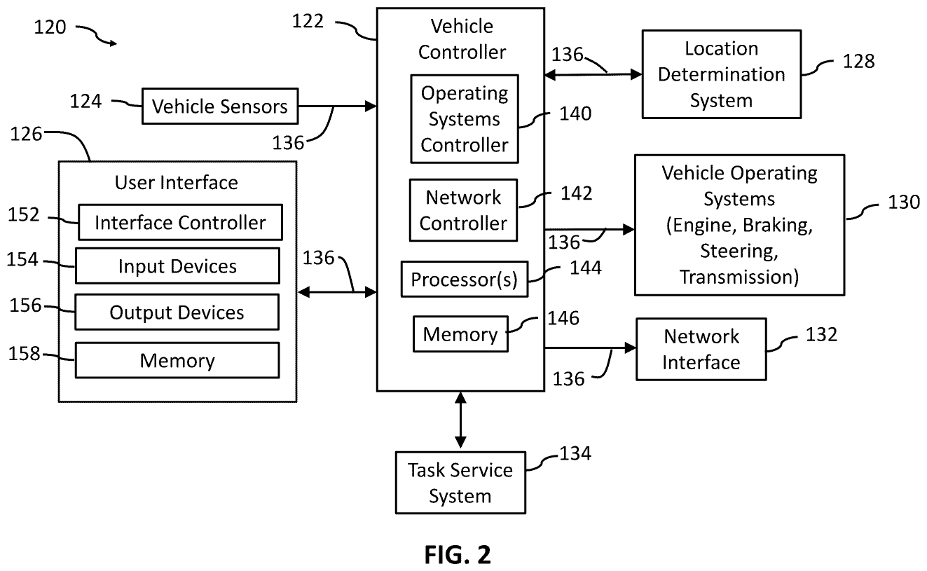

Referring also to FIG. 2, a system diagram of utility vehicle 100 is depicted. Utility vehicle system 120 as depicted includes portions of electrical, control, and communication systems of utility vehicle 100, which in an embodiment includes vehicle controller 122, vehicle sensors 124, user interface 126, location determination system 128, vehicle operating systems 130, network interface 132 and task service system 134, and vehicle controller area networks (CAN) bus 136.

Vehicle controller 122, in an embodiment, comprises a vehicle electronic control module with one or more electronic control units (ECUs) with processors and memory for controlling electrical systems or subsystems of utility vehicle 100. Vehicle controller 122 may comprise a single control device or distributed control devices. Functions of vehicle controller 122 may be performed by hardware and/or computer instructions saved on non-transient, computer-readable storage mediums, such as memory 146. Controllers within, or connected to, vehicle controller 122 may use memory 146 to store and/or retrieve information.

In the embodiment depicted, vehicle controller 122 includes operating systems controller 140, network controller 142, one or more processors 144 and memory 146. Additional controllers or ECUs not depicted may also be present, such as those specific to control operating systems 130 or other connected devices. Operating systems controller 140, which may include multiple ECUs is configured to control the various operating system 130, including engine/prime mover 110, transmission system 112, braking system 114 and steering system 116. Network controller 142, in an embodiment, facilitates communication of devices connected to vehicle controller 122 over controller area network 136, as discussed further below.

Memory 146, in an embodiment, includes computer-readable media in the form of volatile and/or nonvolatile memory and may be removable and/or non-removable. Embodiments include random access memory (RAM), read only memory (ROM), electronically erasable programmable read only memory (EE-PROM), flash memory, optical or magnetic storage devices, and/or other medium that can be used to store information and can be accessed by electronic devices.

User interface 126 is in electrical communication with vehicle controller 122, and may comprise any of a variety of human-machine interface devices configured to receive input from a user and transmit the received input to vehicle controller 122, as well as to receive an output from vehicle controller 122 and communicate or present that output to a user. In an embodiment, user interface 126 includes interface controller 152, input devices 154, output devices 156 and memory 158.

Interface controller 152 may be configured to control operations of user interface 126 and its subsystems, as well as input devices 154 and output devices 156. Interface controller 126 may include or form a portion of a processing system that includes one or more computing devices that may include memory, processing and communication hardware. Interface controller 152 may be a single device or a distributed device, and functions may be performed by hardware and/or as computer instructions on a non-transient computer-readable storage medium, such as memory 158, which shares the properties described above with respect to memory 146. As described further below, interface controller 152 may interpret input from input devices 154, particularly “touches” from a user touching an input device 124 that includes a touch-screen display.

Input devices 154 may include touch-screen displays, frequency-operated buttons (FOBs), buttons, switches, selectors and so on.

Output devices 156 may include displays, touch screens (that function as both output and input devices), lights, audio devices, tactile devices and other such suitable output devices.

Location-determination system 128, in an embodiment, is configured to determine a current location of utility vehicle 100, such that utility vehicle 100 is a “location-aware” vehicle. Location-determination system 128 is in communication with vehicle controller 122 through CAN bus 136, or alternately, through a wireless network. In an embodiment, location-determination system 128 includes comprises a global positioning system (GPS). In another embodiment, location-determination system 128 may comprise a vehicle telematics system.

Vehicle operations systems 130 includes the various operations systems of utility vehicle 100, such as prime mover 110 with its associated components and systems, transmission system 112, braking system 114, steering system 116, and other vehicle systems associated with vehicle operations.

Network interface 132, in an embodiment, is connected to, or in communications with, vehicle controller 122, and is configured to connect utility vehicle 100 to an external computer network, such as the internet, or a local area network. In an embodiment, network interface 132 may comprise a network controller, transmitter, receiver, and various hardware and software computer instructions saved in a memory device.

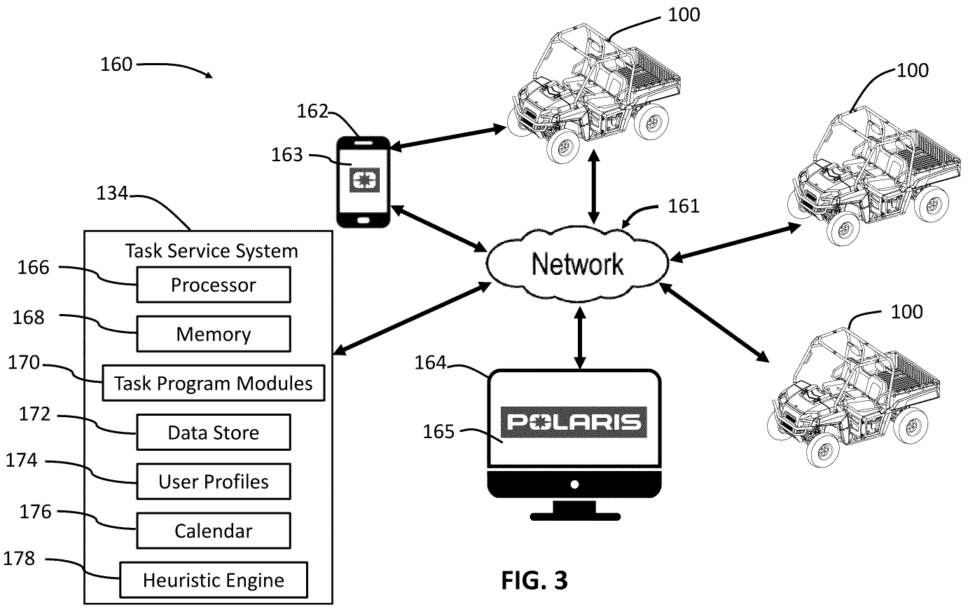

Task service system 134, in an embodiment, and as described in further detail below with respect to FIG. 3, comprises computing devices, including hardware such as processors and memory devices, as well as computer software and instructions stored in the memory devices. Task service system 134 may be integrated into utility vehicle 100, or may fully or partially be located remote to utility vehicle 100. Task service system 134 is in communication with vehicle controller 122 and provides and supports the various task-oriented functionality and features described herein. As also described further below, task service system 134 may be accessed by utility vehicle 100, a remote computing device, such as a smart phone, or another remote computing device.

CAN bus 136 comprises a vehicle bus system that connects the various devices of system 120, facilitating communications between the devices. In an embodiment, CAN bus 136 may comprise a single vehicle controller area network, or may comprise portions of multiple, system specific CAN buses 136, such as a vehicle CAN bus, peripheral CAN bus, telematics CAN bus, and so on.

Referring to FIG. 3, an embodiment of a system 160 for managing location-based tasks is depicted. In the depicted embodiment, system 160 includes a plurality of location-aware utility vehicles 100, mobile computing device 162, remote computing device 164, task service system 134, connected to each other via network 161.

Network 161 may comprise any of a variety of wide-area computer networks, local-area computer networks, personal-area networks, and so on, such as the Internet.

In an embodiment, mobile computing device 162 may comprise a hand-held mobile computing device, such as a smart phone, tablet or other such device. Mobile computing device 162 includes a user interface 163, which in an embodiment, includes a display screen, which may be a touch-screen display screen. Mobile computing device 162 may connect to network 161 and vehicles 100 via a wireless connection technology, such as via WiFi®, Bluetooth, radio-frequency (RF), cellular, satellite and other such wireless networking technologies. Mobile computing device 162 may include a user interface for receiving user input, such as a touch screen or keyboard, and for displaying and conveying information to a user, along with a processor and memory. Mobile computing device 162 may also comprise a location-based task-management software application that includes computer program instructions saved at least partially in a memory of device 162, for implementing the various location-based, vehicle-centric methods described herein. Although in some embodiments, system 160 includes one or more mobile computing devices 162, in other embodiments, system 160 may not include any mobile computing devices.

Remote computing device 164, in an embodiment, comprises an optional second computing device connected to network 161 and utility vehicles 100. In an embodiment, remote computing device 164 comprises a desktop or laptop computer connected to network 161, and may include a user interface 165 for receiving user input, such as a display screen and keyboard, along with a processor and memory. Remote computing device 164 may also comprise a location-based task-management software application that includes computer program instructions saved at least partially in a memory of device 164, for implementing the various location-based, vehicle-centric methods described herein. Although in some embodiments, system 160 includes one or more remote computing devices 164, in other embodiments, system 160 may not include any mobile computing devices.

Remote computing device 164, and in some cases, mobile computing device 162, may access location-based task-management computer program software stored in a server or other computer device connected to network 161, such that functions of location-based task management system 160 may be accomplished by a user operating computing device 162 or 164 via internet or “web-based” computer program instructions or software.

Similarly, each location-aware utility vehicle 100 may also include location-based task-management computer program software stored locally in a memory device of vehicle 100, such as memory 146. Alternatively, or additionally, vehicle 100 may be configured to access such computer-readable instructions, i.e., software programs or applications, stored in task-service system 134 and/or stored in other remote memories connected to network 161.

In operation, each of the plurality of location-aware utility vehicles 100, mobile computing device 162 and/or remote computing device 164 are configured to connect to task-service system 134. As depicted, this connection is made through network 161. Although task-service system 134 is presented as a separate, standalone system, it will be understood that task-service system 134 may alternatively comprise a distributed system.

In an embodiment, task service system 134 includes one or more processors or controllers 166 and one or more memory devices 168. Task service system 134 may also include location-based task-management software application modules, or “task program” modules stored in memory 168. In some embodiments, task program modules may be stored in other memory devices connected to network 161. Data store 162 stores information necessary for the operation of system 160, such as vehicle 100 data, location data, user data, task data, and so on.

Data store 172 may be part of, or utilize, memory 168. User profiles 174 providing information on system users and vehicles may also be stored as part of data store 172. In an embodiment, task service system 134 may also include a calendar application and/or calendar information. In some embodiments, task service system 134 also includes heuristic engine 178, which in an embodiment comprises computer program instructions saved in memory that perform heuristic analysis over time to learn from, and improve upon, operations and usage of the location-based, vehicle centric methods of system 160.

In general operation, and as described in greater detail below, users may access task-service system 134 through a user interface, such as a user interface of a location-aware vehicle 100, a user interface of mobile computing device 162 or a remote computing device 164 to implement location-based, task-management methods involving utility vehicles 100.

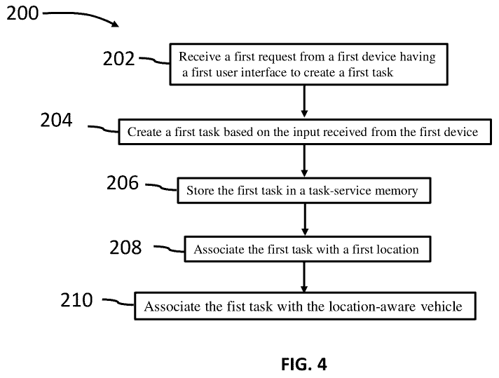

Referring to FIG. 4, in an embodiment, method 200 for managing location-based tasks for a location-aware vehicle 100, is depicted and described.

At step 202, a first request from a first device having a first user interface to create a first task is received. In an embodiment, the first request is input by a user interacting with a user interface, and is received at task service system 134, such as at processor or controller 166. The first user interface of the first device may be a user interface 126 of a location-aware vehicle 100, a user interface of mobile computing device 162 or a user interface of a remote computing device 164. In an embodiment, the first request is transmitted over network 161; in another embodiment, the first request is transmitted over CAN bus 136, or another network. Types of tasks and their details are described in further detail below, but may include location-specific tasks such as mending fences, mowing a field, and so on.

At step 204, a first task is created based on the input received from the first device. A task may include, or be defined by, task content having a variety of features or characteristics, such as a task name, task location, vehicle, task date, user, due date, and so on. In an embodiment, the first task is created by task service system 134 and its processor 166.

At step 206, the first task is stored in a memory device, such as task-service system 134 memory 168.

At step 208 the first task is associated with a first location. The first location may be a location defined by coordinates to be a specific location, may be an area of a location, may be a track or route, or may be another similarly defined location. The association may be accomplished by task service system 134 using its processor 166 to process the data and save it into data store 172.

At step 210, the first task is associated with one or more location-aware vehicles 100. In an embodiment, the association may be accomplished by task service system 134 using its processor 166 to process the data and save it into data store 172.

Referring also to FIG. 3, the steps of method 200 for managing location-based tasks for a location-aware vehicle, as described above, may be implemented by a user accessing system 160 for managing location-based tasks and task service system 134 via a user interface, such as a user interface 126 of a utility vehicle 100, a user interface of a mobile computing device 162 or a user interface of a remote computing device 164. To facilitate operation of system 160, the various user interfaces, including user interface 126, may include a display screen, and each is configured to display a plurality of different graphical user interfaces (GUIs) to a user of the system, which may also be an operator of a utility vehicle 100.

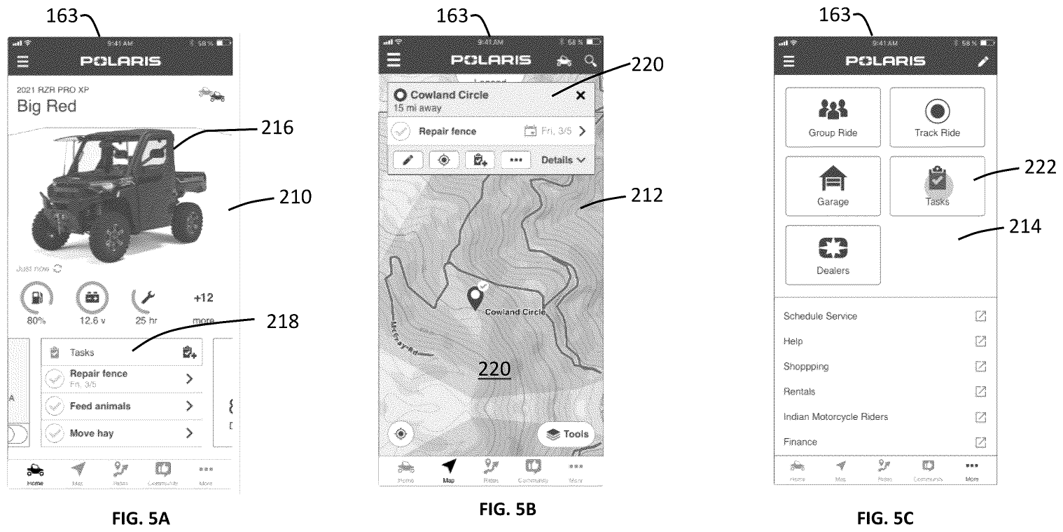

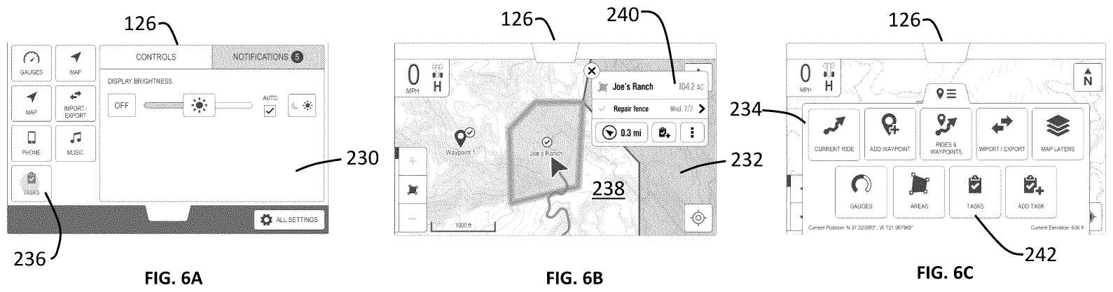

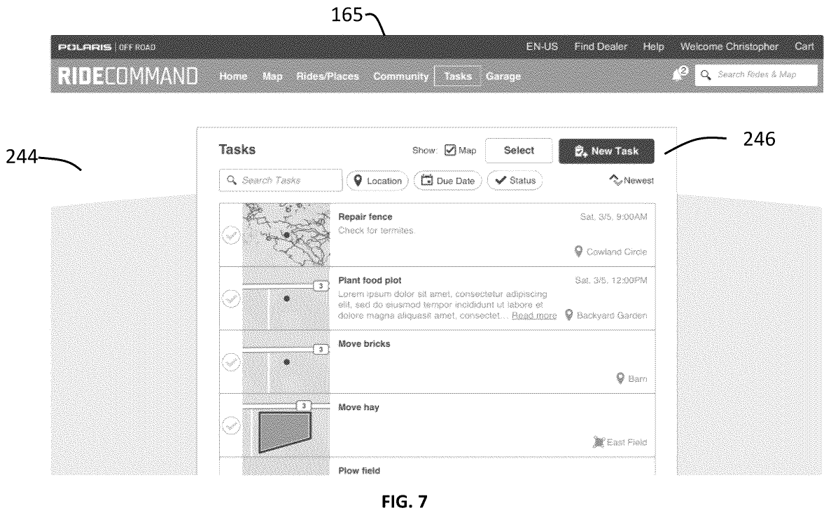

Referring to FIGS. 5A, 5B and 5C, task-management-access GUIs 210, 212 and 214 are respectively displayed on a display screen of user interface 163 of mobile computing device 162. As will be described below with respect to FIGS. 6 and 7, similar task-management-access GUIs for launching and accessing system 160 for managing location-based tasks and task service system 134 may be displayed on user interfaces for utility vehicle 100 and web-based remote computing device 164. Throughout the description of the various depicted GUIs described below, reference to devices and systems of FIGS. 2 and 3, depicting location-based task management system 160 and task-service system 134 will also be made.

Still referring to FIGS. 5A, 5B and 5C, a user may interact with user interface 163 and one or more GUIs 210, 212 and 214 to launch and access systems 160 and 134 by selecting various displayed graphical components, such as graphical icons, radio buttons, menus and menu items, scroll bars, and so on. In an embodiment, location-based task management system 160 may be accessed and launched by a user interacting with any of a plurality of task-management-access GUIS, including GUIs 210, 212 and 214.

Referring specifically to FIG. 5A, first task-management-access GUI 210 displays a home tab card displaying a graphical representation 216 of utility vehicle 100 providing vehicle information, as well as a graphical task menu 218. Selection of task menu 216 by a user opens other location-based task-management GUIs for creation and management of location-based, vehicle-centric tasks to be displayed.

Referring to FIG. 5B, second task-management-access GUI 212 displays a graphical map 220 with a location-based task management menu 222 overlaid on the map 220. In other words, location-based task management system 160 may be accessed and operated from a mapping application receiving location information from location determination system 128 (FIG. 2).

Referring to FIG. 5C, third task-management-access GUI 214 displays another graphical access interface displaying graphical buttons for various functions and systems, including a “tasks” button 224 that launches the software application of location-based task management system 160. In an embodiment, GUI 214 is displayed as part of a mapping application, as a “more” feature in the mapping application.

Consequently, system 160 is configured to display several different GUIs for a mobile computing device 162 that may be displayed on a user interface 163 to launch and access location-based task-management system 160 and its features.

As described briefly above, a user may also access location-based task-management system 160 and its features by interacting with user interface 126 on utility vehicle 100, or by interacting with user interface 165 of remote computing device 162.

Referring to FIGS. 6A, 6B and 6C, embodiments of task-management-access GUIS 230, 232 and 234 are respectively depicted, as displayed on a display screen of an output device 156 of user interface 126 of utility vehicle 100. GUIS 230, 232 and 234 are generally analogous to GUIs 210, 212 and 214 that facilitate access to system 160 via mobile computing device 162.

Referring specifically to FIG. 6A, first task-management-access GUI 230 displays a badge-panel GUI displaying a graphical representation of a tasks button 236 as part of a badge-panel GUI. Selection of graphical task button 236 by a user opens other location-based task-management GUIs for creation and management of location-based, vehicle-centric tasks to be displayed.

Referring to FIG. 6B, second task-management-access GUI 232 displays a graphical map 238 with a location-based task management menu 240 overlaid on the map 238. In other words, location-based task management system 160 may be accessed and operated from a mapping application receiving location information from location determination system 128 (FIG. 2).

Referring to FIG. 6C, third task-management-access GUI 234 displays another graphical access interface displaying graphical buttons for various functions and systems, including a “tasks” button 242 that launches the software application of location-based task management system 160. In an embodiment, GUI 234 is displayed as part of a mapping application, as a “more” feature in the mapping application.

Referring to FIG. 7, an embodiment of task-management-access GUI 244 as displayed on a display screen of user interface 165 of web-based remote computing device 164 is depicted. Similar to the task-management-access GUIs of mobile computing device 162 and vehicle 100, GUI 244 facilitates access to system 160 via remote computing device 164.

In an embodiment, and as depicted, GUI 244 is displayed when a “Tasks” button is selected from a top menu bar of a mapping system application associated with utility vehicle 100. Selection of the Tasks button on the title bar displays GUI 244 that includes task list 246. Creation of tasks, task lists, and management of tasks and task lists are described in further detail below.

In the following description, operation of system 160 for managing location-based tasks and task service system 134, including creating tasks, assigning tasks, managing task materials, associating a task location, creating task worklists and so on, will be explained primarily in conjunction with GUIs configured to be displayed on interface 163 of mobile computing device 162. However, it will be understood that such operations and processes may be accomplished through display and interaction with user interfaces 126 of utility vehicle 100 and user interface 165 of remote computing device 164, displaying GUIs similar to those adapted specifically for mobile computing device 162.

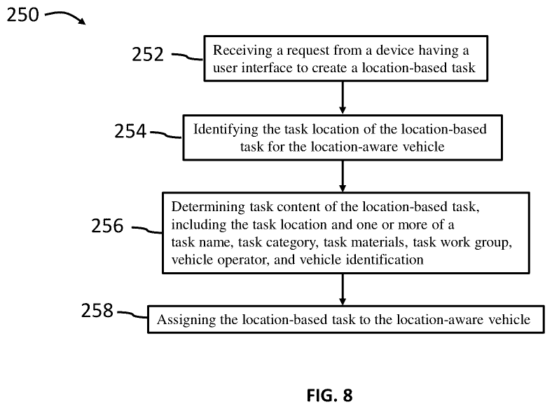

Referring to FIG. 8, method 250 for creating a location-based task for a location-aware vehicle is depicted and described.

Step 252, in an embodiment, comprises receiving a task-creation request from a device having a user interface to create a location-based task. The request may be caused by a user interacting with a user interface 126 of location-aware vehicle 100, user interface 163 of mobile computing device 162 or user interface 165 of remote computing device 164. The data corresponding to the task-creation request may be transmitted to task service system 134 over network 161 in the case of the user interface 126, or may be transmitted via vehicle controller 122 to task service system 134 in the case of input at vehicle 100.

Step 254, in an embodiment, comprises identifying the task location of the location-based task for the location-aware vehicle. The task location may be identified in a variety of different ways. In an embodiment, location determination system 128 may be queried to provide a location of a location-aware utility vehicle 100, and the current location of vehicle 100 may be identified as not only the location of the vehicle 100, but also the location associated with the task. In another embodiment, a user selects a location using a map displayed on the user interface. In another embodiment, a user selects a predetermined map route, map track or location area saved in a memory device, such as a local memory device 146 or 158 of vehicle 100, or in a remote memory device such as memory device 168 of task service system 134 or a remote memory device of mobile computing device 162 or remote computing device 164. In yet another embodiment, a user may enter location coordinates into the user interface to define the task location. The above-described embodiments for identifying a task location are not intended to be limiting, and other embodiments for identifying a task location are herein contemplated.

Step 256, in an embodiment, comprises determining task content of the location-based task, including the task location and one or more of a task name, task category, task materials, task work group, vehicle operator, and vehicle identification. In an embodiment, task content may be stored in data store 172 and accessed via task-service system 134. Task content may be selected by a user interacting with a user interface to select presented content, or may be provided directly from the user and stored in a memory device, such as memory device 168 with data store 172 of task service system 134.

Step 258, in an embodiment, comprises assigning the location-based task to a location-aware vehicle 100. Assignment of a location-based task to a location-aware vehicle may be accomplished by displaying a choice of vehicles 100 available for assignment to a user via one of the user interfaces, followed by the user selecting a vehicle 100 to be assigned and transmission of data corresponding to the assignment to task service system 134, which may be over network 161. Assignment of a location-based task to a location-aware vehicle may be accomplished in other ways, such as by direct input from the user into a user interface, or by other methods, described in further detail below with respect to GUIs associated with task creation.

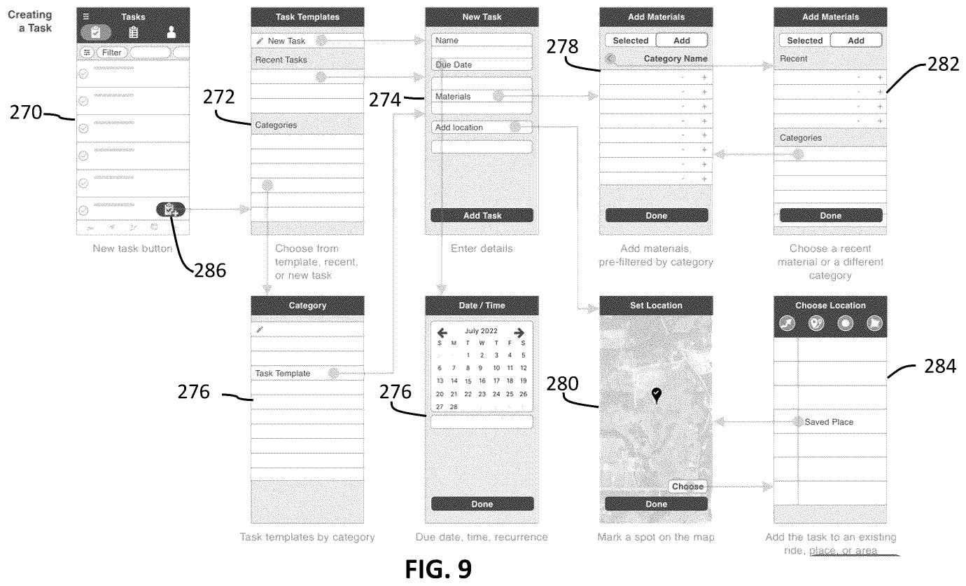

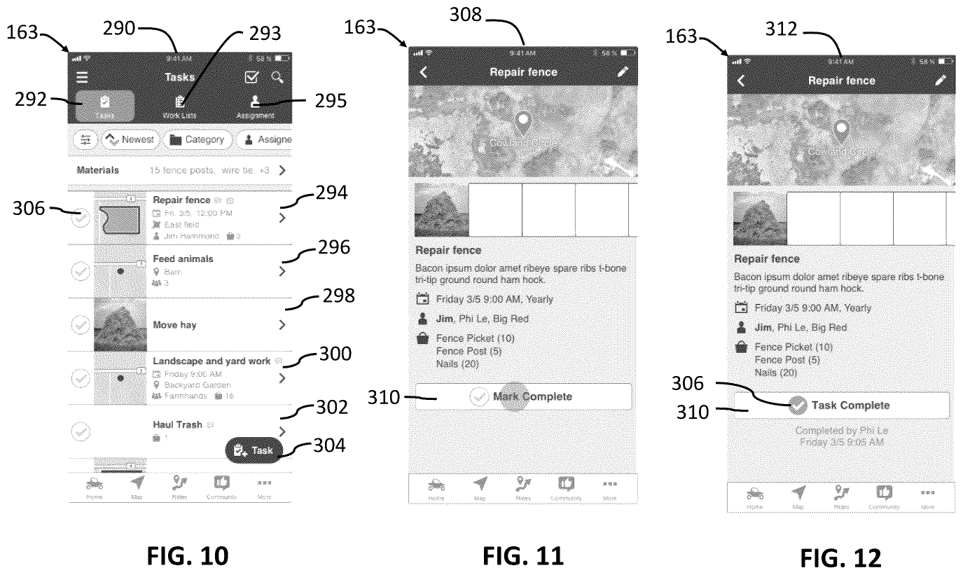

Referring to FIG. 9, a series of GUIs 270-284 illustrates an embodiment of method 250 for creating a location-based task for a location-aware vehicle. FIGS. 10-15 illustrate further embodiments of GUIs for creating a location-based task.

Referring specifically to FIG. 9, location-based task management system 160 with task service system 134 causes GUI 270 to be displayed on user interface 163. GUI 270 depicts a graphical task menu that includes a new-task graphical button 286, which may be selected by a user to create a new task. After selection of the graphical new-task button 286, in an embodiment, location-based task management system 160 with task service system 134 causes GUI 272 to be displayed. GUI 272 displays and enables three ways to create a task: directly create a new task, duplicate a recent task, or create a new task from an existing template.

In the embodiment of creating a task from an existing task template, GUI 272 displays category list 288 listing a plurality of task categories. Upon selection of a category, GUI 276 is displayed. GUI 276, in an embodiment, displays a task template for the selected category. Task categories may be predefined, including being predefined by a user, and may include a variety of task categories, such as farming, mowing, repairing, and so on. Each task category may include a task template refined to capture task content relative to that particular category of task. For example, the farming task may populate a template with different equipment as compared to a template corresponding to repairing.

Following selection of a category template via GUI 276, selection of “new task”, or selection of recent tasks, new-task GUI 274 is displayed on the user interface.

GUI 274 presents a framework for identifying task content. As described above, task content may include a task name, category, due date, user or vehicle assignment, materials required or recommended, notes, task location, photos and other associated content. Certain task content may be predefined, particularly if the new task is derived from a category template, or from a recent task. Some task content may need to be filled in, or received by, a user, for example, task due date and location.

In an embodiment, upon receiving an input from an input device 154 actuated by a user selecting a graphical “due date” button displayed on the user interface, systems 160 and 134 cause calendar GUI 276, which in an embodiment, includes dates selectable by a user, to be displayed on a user interface. Following selection of a date by a user, the due date for the task is saved in a memory device.

In an embodiment, a due date may be optional, and a user may be prompted to choose whether the task should be assigned a specific date and/or time for completion.

Further, tasks may be assigned recurring due dates. In such an embodiment, a daily, weekly, monthly or yearly due date(s) may be selected.

Selection of a “materials” button of GUI 274 causes materials GUI 278 to be displayed on the user interface. A list of predetermined and selectable materials may be displayed to a user for selection. Alternatively, or in addition, a user may input one or more materials to be associated with the task via the user interface, to be saved in memory and associated with the new task. System features relating to materials are described further below.

Selection of the “add location” button of GUI 274 results in location GUI 280 being displayed. In an embodiment, and as depicted, location GUI 280 may display a map. The displayed map may be interactive, such that a user may select a location on the map to be associated with the task being created, in conjunction with GUI 284.

Based on the above methods, a location-based task with its task content is created and saved in memory 168 of task service system 134.

FIGS. 10-15 depict and describe GUISs displayed on user interface 163 of mobile computing device 162, illustrating features relating to creation and display of location-based tasks, task content, and task completion. As described further below, such GUIs may also be displayed on user interface devices of vehicle 100 and remote computing device 164.

Referring specifically to FIG. 10, task list GUI 290 is displayed on user interface 163. In this embodiment, GUI 290 at a top portion displays three primary icons, namely, tasks icon 292, work lists icon 293 and assignment icon 295. In an embodiment, when graphical Tasks button 292 is selected, a list of tasks with task contents is displayed, as displayed by GUI 290. In the depicted embodiment, five tasks 294, 296, 298, 300 and 302 are displayed in row format with their associated task content. In some embodiments, the type and amount of task content displayed may vary from task to task. For example, task 294 with task content as displayed includes a task name, associated user, task location and task due date. In contrast, task 296 as displayed includes different task content, namely, a task name and a photo.

Task list GUI 290 may also display a graphical add task button 304 for adding new tasks.

Further, when displaying a task list, a task completion status may be indicated by displaying a task-completion indicator 306, such as the “check mark”, located next to each task. In an embodiment, the task-completion indicator 306 may appear only faintly to indicate that the task is incomplete. When a user interacting with an input device of the user interface selects or depresses the graphical task-completion indicator 306, the indicator may change appearance, such as changing color or brightness, to indicate that the task is complete. As described with respect to FIG. 11, a completion status of a task may be changed from other screens or GUIs.

In an embodiment, selection of a particular task from the task list causes a task-specific GUI displaying detailed task content information to be displayed. Referring to FIG. 11, task-specific GUI 308 is depicted. In this embodiment, additional details regarding an individual task are displayed.

In addition to viewing detailed task information, a graphical status-completion icon or button 310 is displayed. In an embodiment, when the task completion status is incomplete, the status-completion icon or button 310 may include text indicating that task is incomplete, such as by displaying text: “Mark Complete.” Referring also to FIG. 12, selection by a user of “Mark Complete” will change the status-completion icon or bar 310 to display the text Task Complete, and may also change a task status icon 306 as well.

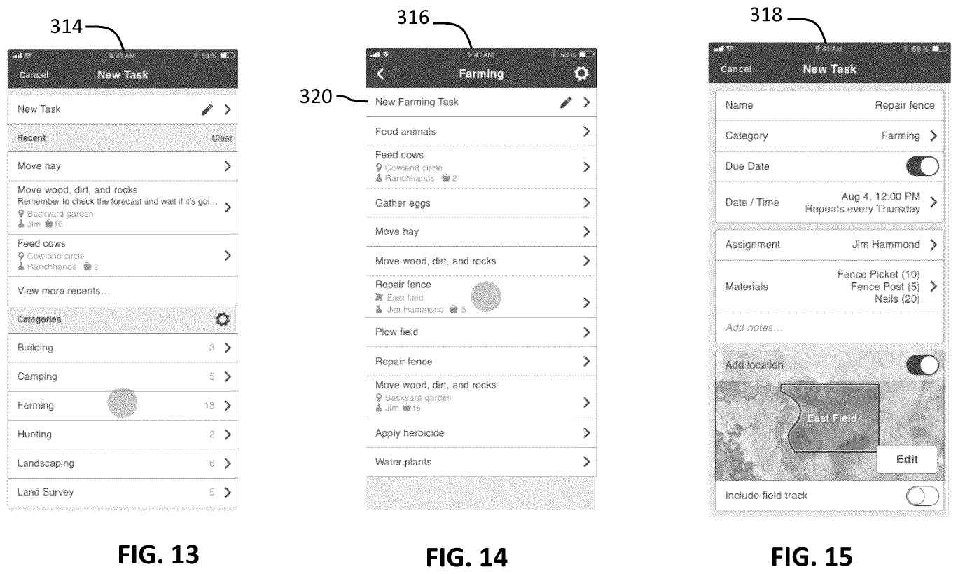

Referring now to FIGS. 13-15, GUIs 314-318 depict additional methods of creating a new task, including selecting a task category. Referring specifically to FIG. 13, in an embodiment, new task GUI 314 displays a list of recent tasks and a list of categories, such as building, camping, farming, hunting, landscaping, land survey, and so on. The list of recent tasks may include detailed task content for each task, or may simply list the task name.

A new task may be created by receiving a selection from a user of a particular task category, which in the provided example, is the “Farming” category. Referring to FIG. 14, once a category is selected, in an embodiment, a list of tasks assigned to the “Farming” category are listed and selectable. If a user selects one of the displayed tasks, those task details are displayed via a GUI similar to the task GUI 308 of FIG. 11. A graphical category-specific new task button 320 is also displayed, and selection of this graphical text button 320 causes system 134 to display a category-specific new task GUI. GUI 318 displays a new farming task GUI that includes task content.

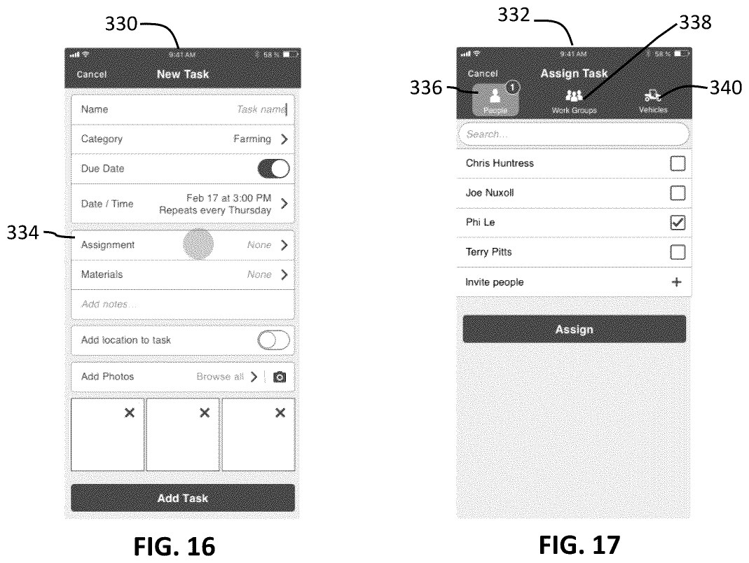

Referring to FIGS. 16 and 17, tasks can be assigned to, or associated with, a particular human user, work group, and/or vehicle. GUIs 330 and 332 depict assigning a user when creating a new task. At new task GUI 330, a user may select graphical assignment button 334, causing a GUI 332 to display people/user icon 336, work group icon 338 and vehicle icon 340. Selection of one of icons 336, 338, or 340 causes a list of available people/users, work groups or vehicles, to respectively be displayed. For example, GUI 332 of FIG. 17 depicts a list of people available for assignment for a task.

In an embodiment, multiple persons, work groups or vehicles may be assigned to a single task.

In an embodiment, the list of available persons may be populated by a list of persons saved in a memory device of system 160 or 134. The list of available persons may also be populated by people that a user is connected to, for example, persons you have invited to participate in task management, persons who have invited the user to participate in task management, persons in a work group in which the user is a member. Other methods for adding and displaying available persons for assignment may include persons in an e-mail contact list, persons associated with work groups of which the user is not a member, and others.

People can be invited by entering their email address and an email invitation will be sent by the task management system. In such an embodiment, location-based task management system 160 may interface with an email client to facilitate email communication. In some embodiments, a request notification may be generated, as described further below.

With respect to utility vehicles 100 available for assignment, a list of vehicles 100 with or without vehicle data may be stored in memory 168 of task service system 134, or elsewhere, and accessed via a user interface. Vehicle data may include a vehicle name, vehicle identification or serial number, vehicle type, such as manufacturer and model, vehicle capabilities, and other vehicle information.

Selection by a user of a particular work group, vehicle or person via a GUI displayed on one of the system user interfaces causes task service system 134 to associate the selected work group, vehicle or person with the task.

Managing assignments of location-based tasks is also described in further detail below.

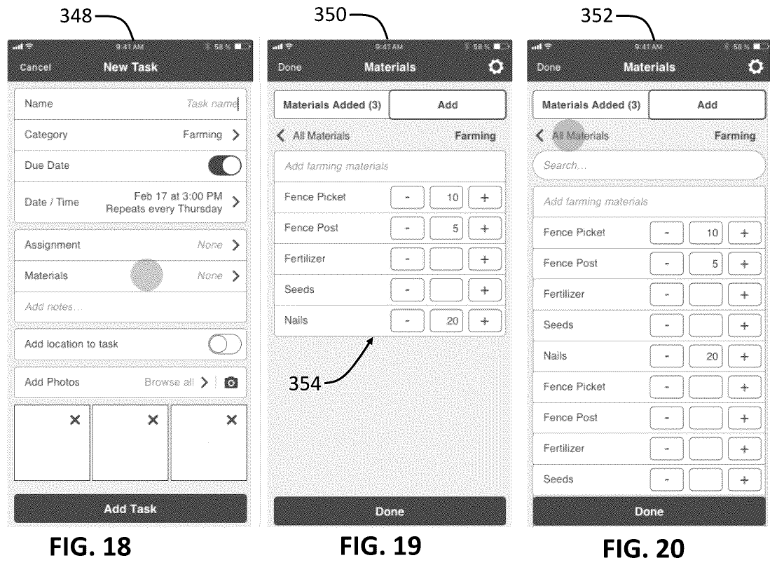

As described in part above, a task can be associated with materials for that particular task. Referring to FIGS. 18-20, GUIs 348, 350 and 352 illustrate steps for associating materials with a task.

In an embodiment, a method of assigning or associating materials to a location-based task includes causing a user interface, such as UI 126 (vehicle), UI 163 (mobile) or 165 (remote) to display a new task GUI, such as GUI 348, followed by receiving a request to associate materials with the new task. The request to associate materials with the new task may be initiated by a user selecting a “materials” button displayed as part of GUI 348, followed by transmitting the request to task service system 134, which receives the request.

After the request to associate materials with a task, in an embodiment, the user interface displays a materials GUI, such as GUI 350. In an embodiment, and as illustrated by GUI 350, a “materials added” and an “add” graphical button may be displayed. The “add” button displays material list 354 that includes or lists available that may be associated with or assigned to the task, such as “fence picket”, “fence post”, “fertilizer”, “seeds” and “nails,” as is depicted in GUI 350.

If a task is associated with a category, the material list includes all materials from that category. Additional materials can be “manually” added by a user, as well as removed.

In an embodiment, “materials” may include tools required to accomplish the location-based task, such as a shovel, hammer, saw and so on. In an embodiment, a group of “tools” may be a subset of materials, or may be associated with a task separately, in a “tools” group, rather than within the “materials” group.

In an embodiment, each displayed material item includes a graphical counter with a “+” and a “−” button to adjust a quantity of each material, so that a user can change the material quantity via the user interface. The quantity can also be changed by displaying a numeric keyboard and receiving a number input from the user interface base on a user input via the keyboard.

In an embodiment, system 160 may be configured to cause a user interface 126, 163 or 165 to remind an operator to bring along required materials or tools, through visual displays on a GUI and/or an audible alert. For example, in an embodiment, a reminder might be: “Alert, you are set to do task (task name), did you pack materials and tools?” The user interface may display options to respond to the reminder, such as “yes” or “view tools and materials needed.” System 160 may then provide a list of tools and/or materials associated with a task. Such a reminder or alert may be issued when system 160 is first started, or begins to leave a location, or begins to drive toward a location identified with the task.

GUI 352 depicts an alternate embodiment of GUI 350, and includes a longer list of available materials.

The selected materials are associated with the task, with data representing both the materials and the task saved in data store 172 of task service system 134.

Selecting the “Materials Added” button causes system 134 to display on the user interface only those materials that were added to, and associated with, the task.

A list of recent materials may also be displayed as a GUI on one of the available user interfaces.

Further, location-based task management system 160 may be configured to associate time-related information with a task. In an embodiment, when creating a task, a user may input an estimated time to accomplish the task. Alternatively, an estimated time to complete a task may be initially associated with any new task based on task category, the estimated time being modifiable by a user. In an embodiment, system 160 may be configured to compare an amount of time left in a day, a work day, or daylight hours to time to completion of a task and provide a notification to the user regarding whether the task may be completed prior to the end of the day, etc. In an embodiment, system 160 is configured to consider or factor in time to travel to and from the task location, as well as time to complete a task.

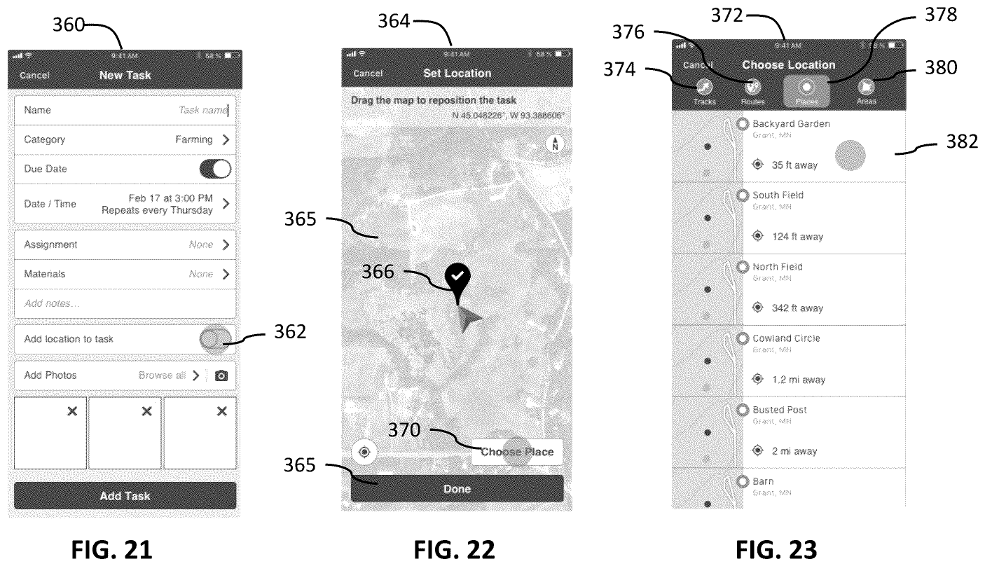

As described briefly above, when creating a new task, in an embodiment, a location is assigned to, or associated with, the task. FIGS. 21-26 elaborate on methods of associating a location with a location-based task.

Referring to FIG. 21, in an embodiment, new task GUI 360 is displayed on a user interface. New task GUI 360 includes a graphical add-location button 362. Selection of button 362 by a user causes a request for associating a location with a location-based task to be received by task service system 134 and its processor 166.

Subsequently, in an embodiment, task service system 134 causes a map to be displayed on the user interface, such as is depicted in GUI 364 of FIG. 22. In an embodiment, map 365 is centered at a current location of the user making the request to add a location. In GUI 364, a location indicator 366 is displayed indicating the user's location. The initial position of the location indicator may be changed by the user to a desired location to be associated with the task, such as by dragging the location indicator icon on the displayed map, or dragging the map while leaving the location indicator centered on the screen or GUI. In an embodiment, after positioning the location indicator on the desired location, a user may select a displayed graphical button, such as button 368, depicted as a “Done” button, to set and associate the location displayed with the location-based task.

Referring also to FIG. 23, alternatively, a location can be set by choosing an existing place or location saved in one of the memory devices of system 160 or 134, to be associated with the task. After selecting a choose-location button 370 of GUI 364, a choose-location or place GUI 372 is displayed on the user interface. In the depicted embodiment, displayed selectable location categories of GUI 372 include tracks, routes, places and areas, which are displayed as graphical icons 374, 376, 378 and 380, respectively.

The track category may include one or more tracks defined by GPS coordinates, or otherwise defined, that define a trail previously traveled or saved in a memory of system 160; the route category may include a plurality of routes defined by GPS coordinates that define a route, such as a route to a destination; the places category may include one or more specific locations that may be defined by GPS coordinates, and may have an associated name; and the areas category may include one or more geographical areas whose boundaries may be defined by GPS coordinates and may include multiple places.

Selection of one of the location-category icons 374, 376, 378, or 380 causes a list of “locations” associated with the selected category to be displayed, as illustrated by GUI 372. In the embodiment depicted, a “places” category of locations has been selected, and a list of places are displayed, such as place 382, named “Backyard Garden” in the depiction of FIG. 23.

In an embodiment, the location is selected from the displayed list by the user. In an embodiment, a set-location GUI may be displayed to the user to confirm that location selected and finalize the association of the selected location with the task, which is saved in a memory of task service system 134.

In an embodiment, system 160 is configured to determine tasks within a fuel range based on current fuel level and expected fuel consumption. In one such embodiment, system 160 may display an alert on a user interface prompting a vehicle operator to obtain more fuel prior to proceeding to a particular destination, or advising that extra fuel would need to be carried or added along the way. System 160 may also take into account an amount of fuel needed for vehicle 100 to return from the task location to a “home” location. Additional descriptions of routing and fuel-related features are described in PCT WIPO Publication No. WO 2021/222206 A1 entitled “System and Method for Dynamic Routing,” published Nov. 4, 2021, and US Patent Application No. US 2022/0308576 A1, entitled “Multi-Vehicle Communication and Control Systems and Methods,” published Sep. 29, 2022, the contents of which are incorporated by reference herein in their entireties.

In an embodiment, system 160 is configured to provide a distance notification via one of the user interfaces as vehicle 100 approaches a location associated with one or more tasks, notifying an operator that vehicle 100 is a calculated distance from the task. System 160 may also display various response options to the vehicle operator such as “ignore” to dismiss the notification, or “view task” to see details of the task as the vehicle approaches the associated location.

In another embodiment, tasks may be searchable based on a distance input by a user or operator, the distance being from vehicle 100, or another predetermined location, to any tasks within a particular radius or distance.

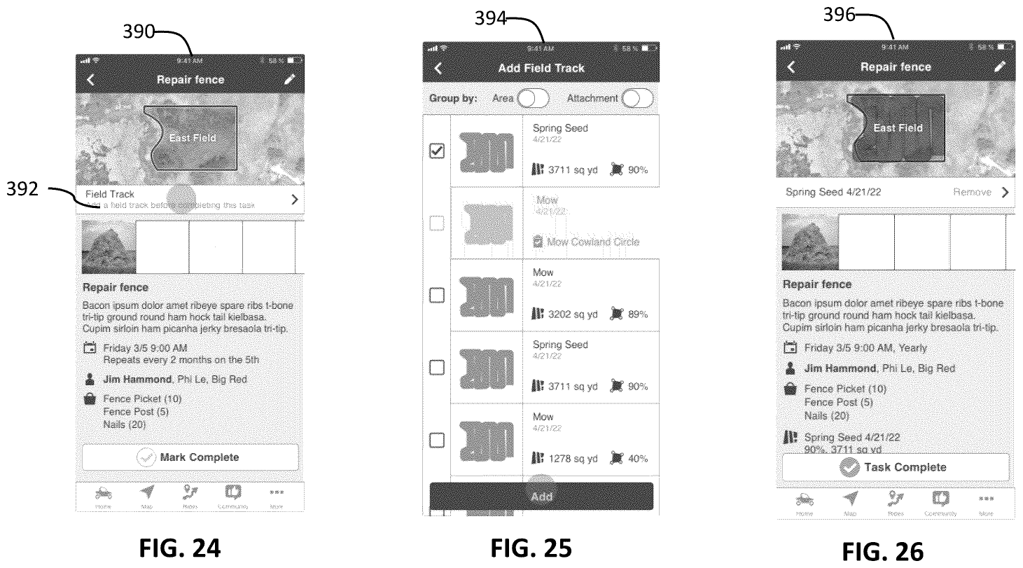

Referring to FIGS. 24-26, in an embodiment, a vehicle-based field track may be added as a location, or associated with a task. A field track may define a path or route to be followed by a vehicle in a designated geographical area, such as an agricultural field.

Referring to FIGS. 24 and 25, GUI 390 includes field-track button 392, which when selected, causes system 134 to display an add-field-track GUI, such as GUI 394. In an embodiment, a list of available, saved field tracks are displayed and selectable by a user.

Referring to FIG. 26, following selection of a field track, the task content may include an indicator that the location includes a field track. In GUI 396, a “repair fence” task and its contents are displayed, with an indication that an associated location is the field track entitled “Spring Seed.”

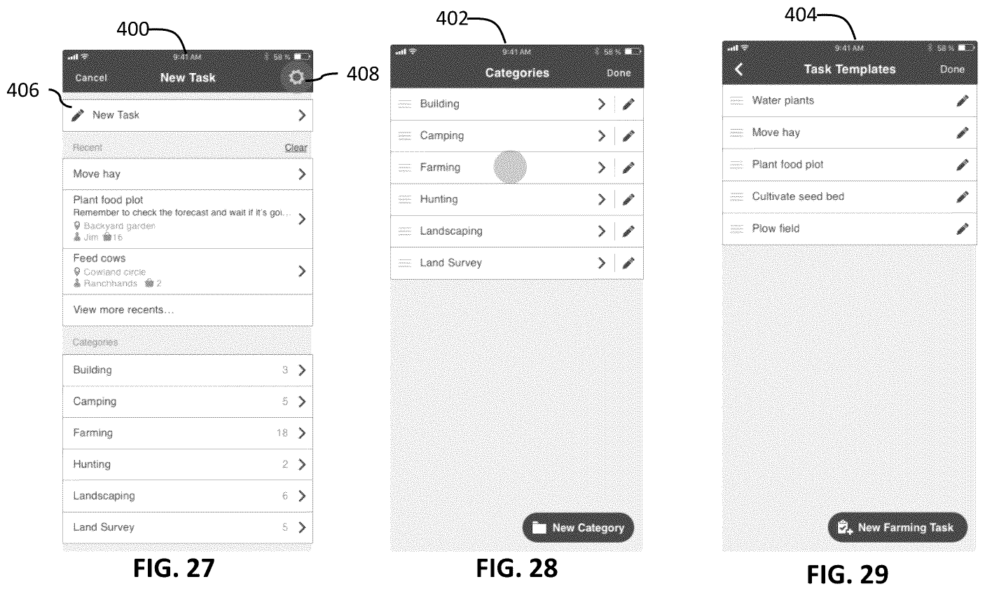

As described in part above, to assist a user with creating a new task and associating task content, such as a location, with the task, a task template with predefined task content may be presented to the user. FIGS. 27-29 depict several GUIs 400, 402 and 404 illustrate further system features relating to task templates, including selecting and editing task templates.

In FIG. 27, new task GUI 400 displays a list of recent tasks and a list of task categories, as well as “new task” button 406. Selecting “new task,” in an embodiment, causes GUI 402 of FIG. 28 to be displayed, which includes a list of task categories, such as building, camping, farming, and so on. Selection of a particular task category results in a list of available templates being displayed and available for selection, as depicted in GUI 404 of FIG. 29. In the example depicted, the farming category is selected via GUI 402, and the selectable task templates are displayed in list form in GUI 404. The example templates include “water plants”, “move hay”, “plant food plot” and so on. Selecting a task template causes the template to be displayed and associated with the task.

In an embodiment, the task templates can be edited by a user. Selecting an icon, such as gear icon 408 of GUI 400 (FIG. 27) causes the template and associated task content to be displayed. The task content may then be changed or edited, then saved.

Task categories can similarly be added, deleted or saved.

Further, templates can be created from an existing task. In an embodiment, a task edit screen or GUI is displayed that includes a “create task template” button, selectable by a user. Selecting the create task template button causes data corresponding to the existing task to be associated with a new task template that may be named and saved in memory 168 of task service system 134.

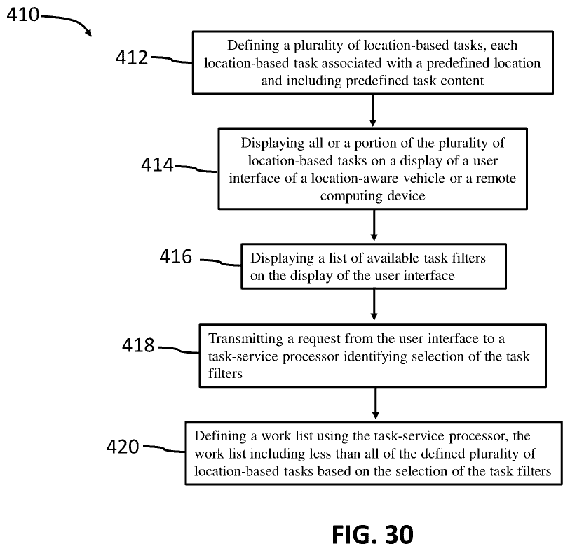

Referring to FIG. 30, after creating and saving of multiple location-based tasks, a task work list may be compiled. Method 410 is a method of creating a work list from a plurality of location-based tasks, and in an embodiment includes steps 412 through 420.

Step 412 comprises defining a plurality of location-based tasks, each location-based task associated with a predefined location and including predefined task content.

Step 414 comprises displaying all or a portion of the plurality of location-based tasks on a display of a user interface of a location-aware vehicle 100, a mobile computing device 162 or a remote computing device 164.

Step 416 comprises displaying a list of available task filters on the display of the user interface.

Step 418 comprises transmitting a request from the user interface to a task-service processor, such as processor 166, identifying selection of the task filters.

Step 420 comprises defining a work list using the task-service processor 166, the work list including less than all of the defined plurality of location-based tasks based on the selection of the task filters.

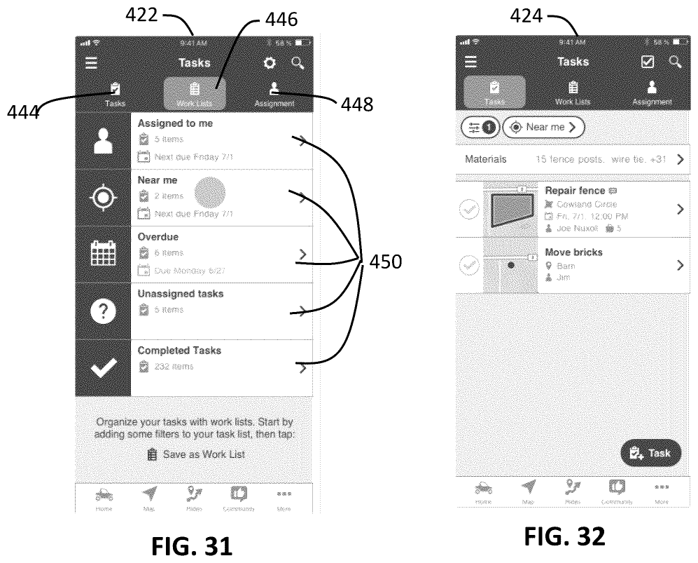

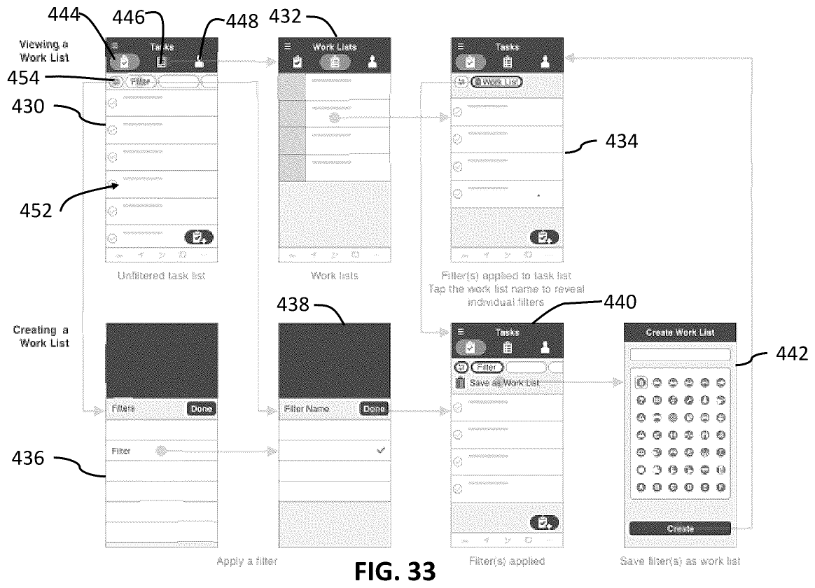

FIG. 31 depicts GUI 422 which depicts a list of available work lists; FIG. 32 depicts GUI 424 which illustrates a particular work list resulting from filtering a list of tasks; and FIG. 33 depicts a series of GUIs 430 to 442 that illustrate an embodiment of method 410 for creating a worklist.

As described further below with respect to the figures, work lists are generally filtered states of defined tasks. In an embodiment, task service system 134 provides a plurality of predetermined work lists based on such criteria as: tasks assigned to a particular user or vehicle, tasks having locations that are located within a predefined distance from a current location of a user or vehicle, tasks thar are overdue, unassigned or completed. Task service system 134 may apply predetermined filters to the task content data saved for each task using processor 166, then save the work lists in memory 168 or data store 172. Graphical representations of these predetermined work list options and work lists may then be displayed on a user interface, such as UI 126, 163 and/or 165. In other embodiments, a user determines filters to be defined to create a user-customized work list.

Referring to FIG. 31, task GUI 422 presents selectable tasks icon 292, work lists icon 293 and assignment icon 295. In this embodiment, work list icon 293 has been selected, causing a list of work-list types or options 450 to be displayed, namely “Assigned to me,” “Near me,” “Overdue,” “Unassigned tasks,” and “Completed tasks.”

When a user selects one of the work list options 450 via interaction with the user interface, a request to create or access a work list is received at task service system 134, causing task service system 134 to display a list of filtered tasks that comprise the work list. Referring to FIG. 32, GUI 424 depicts the location-based tasks that are associated with the “Near me” task-list criteria, namely, tasks located within a predetermined distance from the user. In this embodiment, task service system 134 has analyzed the task content relating to task location, compared the task location to the user's current location, and determined that two task meet the criteria, namely “Repair fence” and “Move bricks.” In an embodiment, a location associated with the task may be displayed, as depicted in GUI 424.

Referring to FIG. 33, systems 160 and 134 are configured to implement method 410 for creating a location-based task work list, as illustrated by the series of GUIs 430 to 442.

In an embodiment, tasks GUI 430 depicts a tasks, work lists and assignments icons 292, 293 and 295, respectively, at an upper location, with an unfiltered list 452 of tasks depicted below. Multiple methods of creating a new work list are available to a user interacting with GUI 430.

A first option for creating a work list starts with selecting filter icon 454 which causes a list of available filters to be presented on the user interface, such as depicted by GUI 436. One or more of the listed filters may be selected, which in an embodiment, results in a visual indicator, such as the depicted check mark, being added adjacent to the filter list item, as depicted in GUI 438. GUI 438 in an embodiment displays a “Done” graphical button, which when selected by a user causes task service system 134 to apply the filters to the saved task list to create a filtered task list. GUI 440 depicts such a filtered task list, along with a graphical “Save as work list” button for saving the filtered task list as a work list. If a user indicates that the filtered task list should be saved as a work list, task service system 134, in an embodiment, displays GUI 442 which allows a user to name the work list and select an icon to represent the work list. Task service system 134 associates the name and icon with the filtered task list as a new work list in memory 168.

In a second option for creating a work list, a “filter” button displayed on tasks GUI 430 is selected, causing GUI 438 to be displayed, bypassing GUI 436. The rest of the steps for creating a work list are as described above with respect to the first options, and GUIs 438, 440 and 442.

In a third option, work tasks icon 293 is selected from tasks GUI 430 causing a list of already-created work lists to be displayed, as illustrated by GUI 432. Selecting a particular work list displayed on GUI 432 causes the list of filtered tasks corresponding to the work list to be displayed, as in GUI 434. In an embodiment, subsequently selecting the “work list” button above the list of filtered tasks causes GUI 440 to be displayed, which depicts a list of filters that are applied. The list of filters can be deselected, or additional filters added, followed by creating a work list as depicted in GUI 442 and also described above.

Not only is system 160 configured to create work lists, but the system also is configured to modify and manage work lists. With respect to modification, an example of modifying an existing work list was described above with respect to GUIS 434 and 440. After opening an existing work list and displaying the filter applied to the saved tasks, filters may be added or removed to modify the work list.

With respect to managing work lists, work lists can be sorted and edited to change names, icons, filters and so on, as well as be deleted or added.

As described above with respect to creating location-based tasks, each location-based tasks is associated with a particular location, including being associated with a specific location, a route, area, and so on. As such, location-based task management system 160 is configured to integrate tasks and task-related items with mapping and location features to provide efficient location-based task management for users and location-aware vehicles 100.

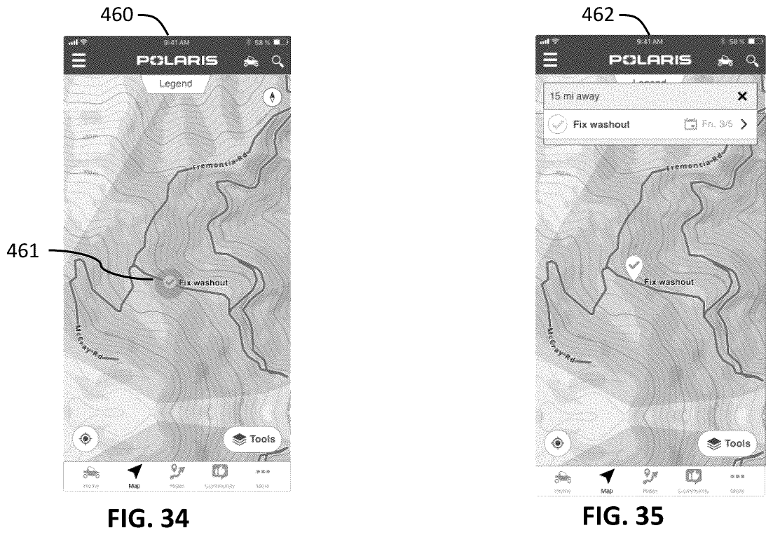

Referring to FIGS. 34-38, various GUIs as displayed on a user interface, i.e., one or more of UI 126, 163 or 165, illustrate the use of mapping for effective location-based task management.

Referring specifically to FIGS. 34 and 35, an ad-loc location of a task is illustrated. GUI 460 depicts a map and a location marker or icon 461 for a particular location-based task, which in this example is named “Fix washout.” This location-based task was created according to methods described above, and saved in task service system 134 memory. In this embodiment, system 160 causes a number of task-related icons to be displayed at a bottom portion of GUI, including a vehicle home icon, map icon, rides icon, community icon, and more icon. Selection of a particular icon causes a relevant GUI to be displayed. With respect to FIG. 34 and GUI 460, the map icon has been selected, and a map of a geographic vicinity is depicted.

In an embodiment, if a location-based task is not yet completed, the location marker for that location-based task, such as the “Fix washout” task, is displayed on the map at the location associated with the task. When the task is designated as complete, in an embodiment, system 160 may cause the location-task indicator to be removed from the map.

In an embodiment, when the location marker or icon for the task is displayed on the map, selection of the icon, such as tapping by a user, causes a pop-up menu describing the task to be displayed, as depicted in GUI 462 of FIG. 35. In an embodiment, the pop-up menu includes the task name and some portions of the task content, such as task due date, or other content which may be configurable by a user. In an embodiment, a user may be able to mark that the task is complete from the pop-up menu. In an embodiment, a location determination system of the user's mobile computing device 162, remote computing device 164 or vehicle 100, such as location determination system 128 of location-aware vehicle 100, may determine a location of the user or vehicle and transmit location data to task service system 134 to be compared to a saved location of the task. Task service system 134 may determine a distance from the user or vehicle to the location associated with the location-based task, and cause a user interface to display that distance on the user interface, such as depicted in GUI 462.

In an embodiment, selection of the displayed task description in GUI 462 causes task details, including task content as described above, to be displayed and available to the user.

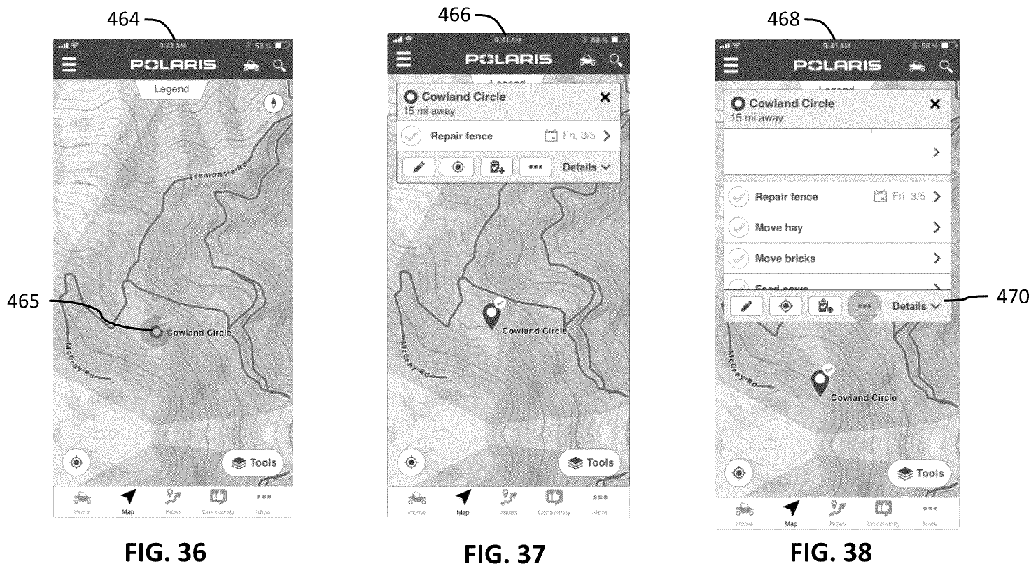

Referring to FIGS. 36 to 38, these figures respectively depict GUIs 464, 466 and 468 that illustrate multiple tasks at a single location as identified on a map. In an embodiment, multiple location-based tasks may be associated with a common location. In one such embodiment, system 160 may cause a user interface to display a map with the location identified and a task/location indicator 465 that indicates that more than one task exists at that location. For example, FIGS. 34 and 35 depict and name a task on the map, i.e., icon 461, in contrast to the GUIs of FIGS. 36-38 which display a different icon, icon 465, identifying a particular location with an indicator, a check mark icon in this example, to notify a user that multiple tasks exist at the location.

Selecting the location displayed via GUI 464 causes a pop-menu to display the details associated with the task(s) and location, as depicted in GUI 466 (FIG. 37) and 468 (FIG. 38). In the embodiment of FIG. 37, there is only one task associated with the location, while in FIG. 38, multiple tasks are associated with the location and disclosed in the pop-up menu. Task details of any of the displayed tasks may be displayed to a user upon selection of the displayed task.

In an embodiment, task tool bar 470 may also be displayed. Task tool bar 470 may include various tool icons that allow a user to edit a task, add a task, zoom on the map to a task, share tasks, and other such functions.

Further, photos associated with the location-based task may be displayed as an overlay at the bottom of the GUI, or may be accessed by selecting an icon.

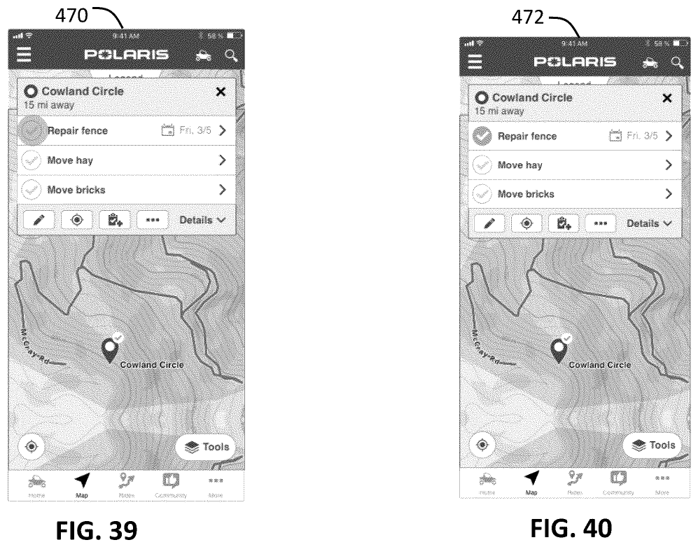

Further with respect to maps, and referring to FIGS. 39 and 40, tasks may be marked as complete while a map with a task location indicator is displayed. GUI 470 depicts a pop-up menu on a displayed map, the menu listing the tasks associated with the location, which in this example is “Cowland circle.” In an embodiment, and as described briefly above, when a task is not considered complete, or not yet “marked” or categorized as complete, system 134 may cause an icon indicating that the location-based task is not yet complete. In an embodiment, and as depicted in FIG. 39, GUI 470, a task completion indicator in the form of a faint circled checkmark is displayed next to the name of the task to indicate that the task is incomplete.

To change the status of the task from complete to incomplete, a user may select or touch the task completion indicator at the display of the user interface. Doing so sends a request from the user interface to task service system 134, causing system 134 to change a status of the task from incomplete to complete. Task service system 134 will also transmit a signal or command to the user interface to display a revised graphical depiction of the task completion indicator to indicate that the task is complete. In an embodiment, a visual appearance of the task completion indicator is changed, such as by changing color, as depicted in GUI 472.

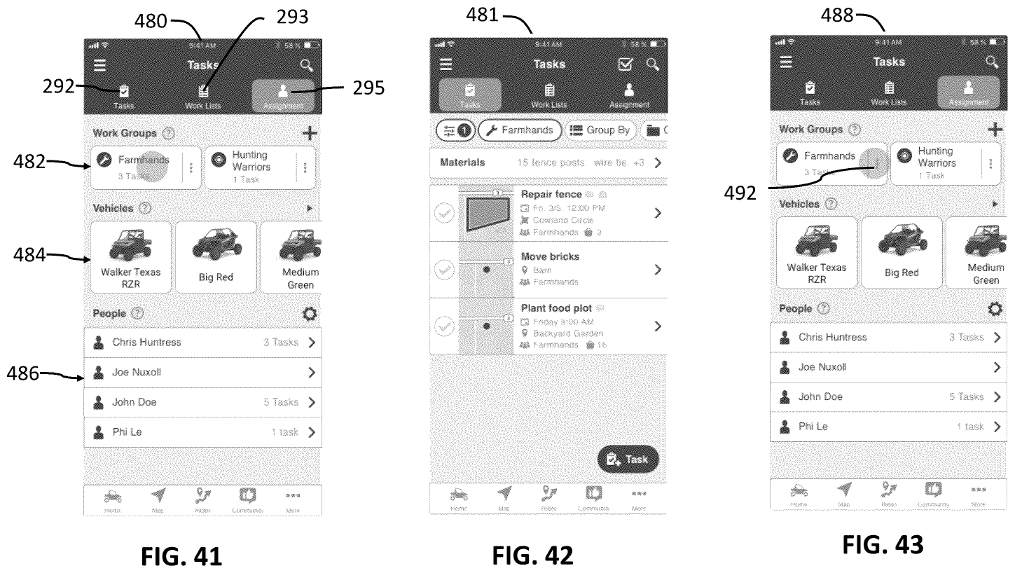

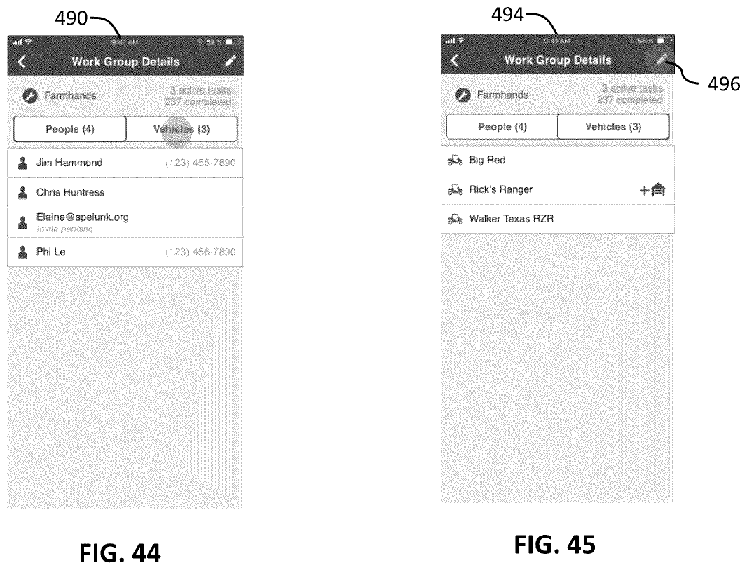

As described in part above, location-based task management system 160 with its task service system 134 is configured to receive input to assign location-based tasks to users, vehicles and/or work groups. FIGS. 41-48 depict and describe a number of features for managing assignments, users and work groups.

Referring specifically to FIGS. 41 and 42, GUIs 480 and 481 illustrate features and methods of displaying, managing and modifying assignments of location-based tasks to one or more work groups. In GUI 480, tasks, work lists and assignment icons 292, 293 and 295 are displayed at a top portion of the GUI, and assignment GUI 295 has been selected by a user interacting with one of the user interfaces 126, 162 or 164 of system 160, causing GUI 480 to be displayed on the user interface, presenting available multiple assignment categories of work groups, vehicles or people/users. Although three assignment categories are depicted and described, it will be understood more or fewer, and different assignment categories are possible.

In an embodiment, the existing and available work groups will be presented in the assignment category of work groups, such as “farmhands” or “Hunting Warriors” depicted as work group row 482 in this embodiment. Various location-aware vehicles 100 may be displayed in association with the vehicle assignment category, such as “Walker Texas RZR,” “Big Red,” and so on, as depicted in work group row 484. One or more persons to which the task may be assigned are depicted in people row 486.

In an embodiment, for each individual work group, vehicle or person displayed as part of the assignment GUI, a quantity of tasks assigned to that work group, vehicle or person is displayed adjacent to the associated icon. For example, the Farmhands work group has three tasks associated with that work group, and user Chris has three tasks assigned to him. Selecting one of the particular work groups, vehicles or persons/users navigates to a displayed task list, as depicted by GUI 480, which is filtered by the selected assignment, which in this depicted embodiment, is “Farmhands.” Selection of a particular vehicle or person would similarly result in a task list filtered by the selected vehicle or person to be displayed and available for modification.

Referring to FIGS. 43-45, work group details can be displayed and modified, as illustrated by GUIs 488 and 490. In an embodiment, task service system 134 causes GUI 484 to be displayed on a user interface, with GUI 484 presenting a “details” icon 492. Selection of details icon 492 causes a request to display details of the selected work group to task service system 134, which in turn causes details of the selected work group saved in memory to be displayed on the user interface. In an embodiment, and as depicted in GUIs 490 and 494, work group details are displayed, and may include information relating to people/users associated with the work group, as well as location-aware vehicles 100 associated with the work group. GUI 490 presents a list of people associated with the work group, while GUI 494 presents a list of location-aware vehicles 100 associated with the work group.

Details of the selected work group can also be modified or edited. In an embodiment, task service system 134 causes a work-group details GUI to be displayed, such as GUI 490 or 494, that includes a displayed edit icon, such as edit icon 496. Selection of edit icon 496 at one of the user interfaces causes system 160 to present graphical information on the user interface for use by the user to edit or change work group characteristics, including adding or removing persons or vehicles in the work group.

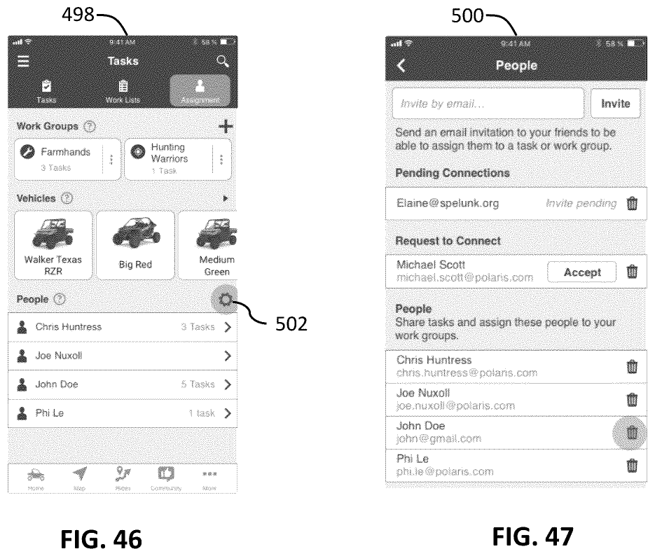

Referring to FIGS. 46 and 47, GUIs 498 and 500 illustrate features relating to management of users of location-based task-management system 160. In an embodiment, system 160 displays a graphical tools or edit icon, such as the gear icon 502, selection of which causes system 160 to display an edit GUI, such as GUI 500, that facilitates management of users of system 160. In an embodiment, users can be added or removed. Further, people can be invited to be users of system 160, such as by email. In one such embodiment, system 160 is configured to send an email to a person, display that the email request to connect is pending, and display received requests to be connected, as illustrated in GUI 500. Location based tasks can also be shared to other users, and persons added or removed from work groups.

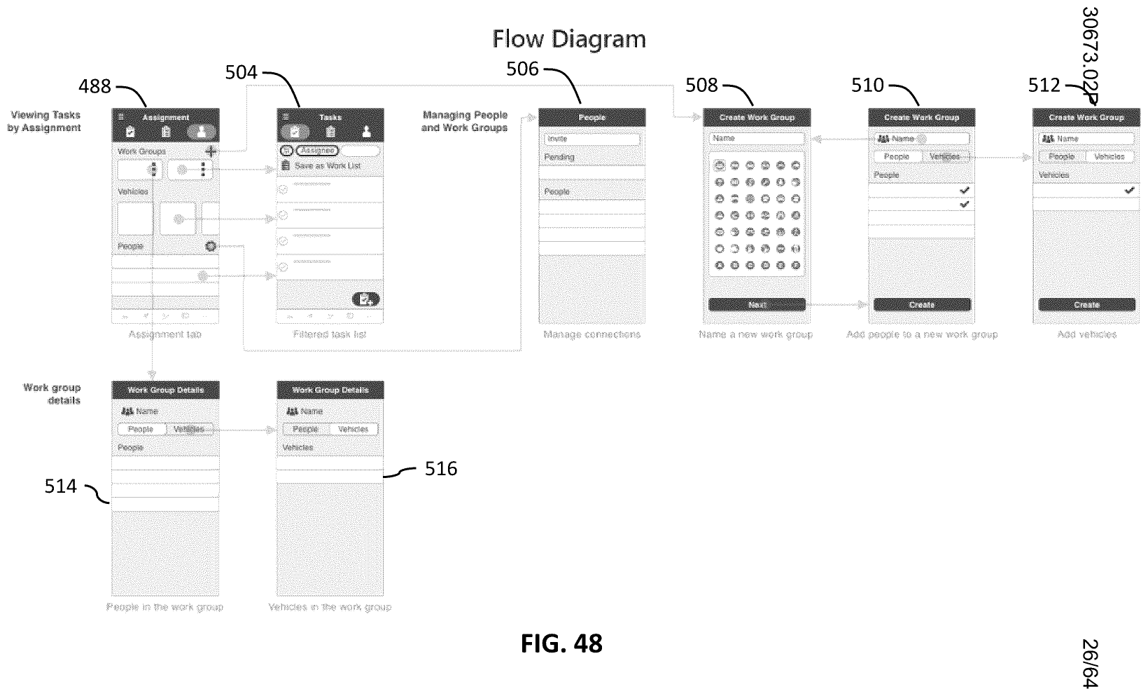

Referring to FIG. 48, a flow diagram for viewing and managing task assignments, as well as managing people and work groups is depicted via a series of GUIs, consistent with the descriptions above for FIGS. 41-47.

In an embodiment, location-based task-management system 160 causes user interface 126, 163 or 165 to display task by assignment, such as GUI 488 displaying rows of work groups, vehicles and people. Selection of a details icon for a particular work group by a user causes system 160 to display work group details, such as by people or vehicles, as illustrated by GUIs 490 and 494, as previously described. Selection of the work group itself causes a list of tasks associated with the selected work group, i.e., filtered according to the work group, is displayed at GUI 504. Selection of a graphical add (+) button from GUI 488 may cause system 160 to display a GUI for creating a new work group, GUI 508, which may be saved in system 134. Work groups can also be created as illustrated by GUIs 510 and 512, and as described above.

Similarly, selecting a particular vehicle 100 or person from the list of vehicles or persons displayed on GUI 488 causes a list of tasks associated with the selected and assigned vehicle or person to be displayed.

Further, management of people can be accomplished by selection of an icon displayed on GUI 488, causing GUI 506 to be displayed.

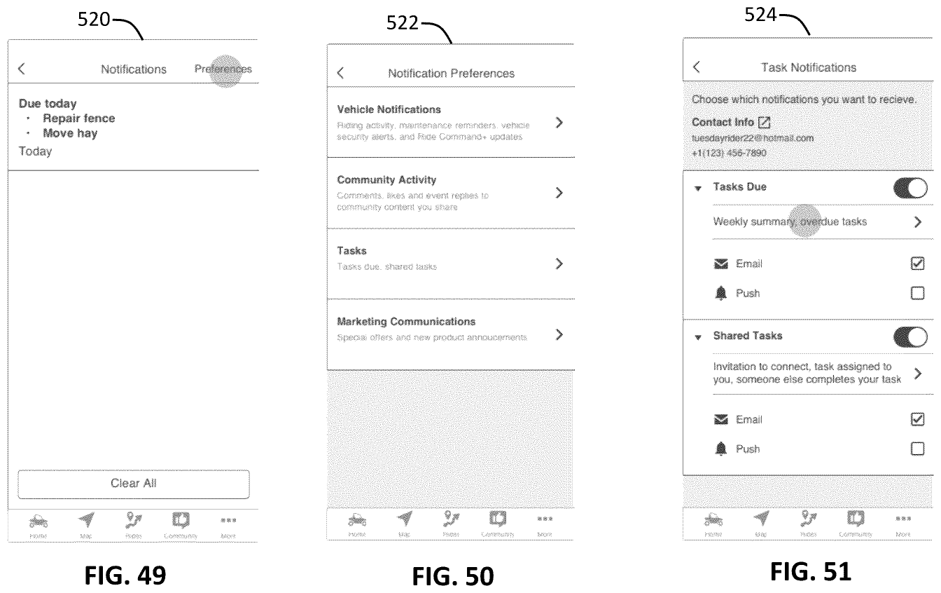

As part of the people/user management features of location-based task-management system 160, the system may provide various task notifications to users, as illustrated by the GUIs of FIGS. 49-51, and as described further below.

Generally, location-based task-management system 160 may be configured to push notification messages to users based on user-specified parameters. Referring specifically to FIG. 49, a notification GUI 520 is depicted. In an embodiment, system 160 causes task notifications to be displayed on the user interface for a particular user. Notification information may include a listing of tasks due on the current date or on future dates. Detailed information may be displayed in response to a user selecting a particular task. Notification information may also include other task-related information relating to changes to tasks by others, availability of users or vehicles to perform tasks, updates on task completion status and other task-related information. The task notification GUI 520 may also display a preferences button or icon that when selection causes system 160 to display a subsequent notification-preferences GUI. FIG. 50 depicts notification-preferences GUI 522, which displays categories of notification preferences, including preference details. Notification preference categories may include, but not be limited to, vehicle notifications, community activities, tasks, marketing communications, and more.

Referring to FIG. 51, in an embodiment, task notifications may be grouped by tasks due and shared tasks, as illustrated by GUI 524. Each category of tasks may have specific notifications that can be turned on and off. Such specific notifications may include tasks due today, tasks that are overdue, or a weekly summary of tasks. Shared tasks may include specific notifications such as notifying a user of an invitation to connect, of tasks assigned to the users, or when someone other than the notified user completes the notified user's task.

How a notification is received may also be configured by a user. Notifications may take the form of a graphical alert being displayed on the user interface, an email, an audible alarm, and so on.

As described above, the various features and methods are accessible to a user interacting with one of the user interfaces, such as user interface 126 of location-aware vehicle 100, user interface 163 of mobile computing device 162 or user interface 165 of remote computing device 164. The various exemplary GUIs described above with respect to the figures may also be displayed on any of the user interfaces 126, 163 and 165, though the exemplary GUIs of the figures primarily are adapted for display on a user interface 163 of a mobile computing device 162. However, in some embodiments, because user interfaces 126, 163 and 165 may differ in size, particularly screen size, as well as keyboard convenience, system 160 may be configured to display and/or provide features unique to the particular user interface in communication with location-based task-management system 160. Examples of GUIs adapted for display on user interfaces 126 and 165 are described below with respect to additional figures and GUIs.

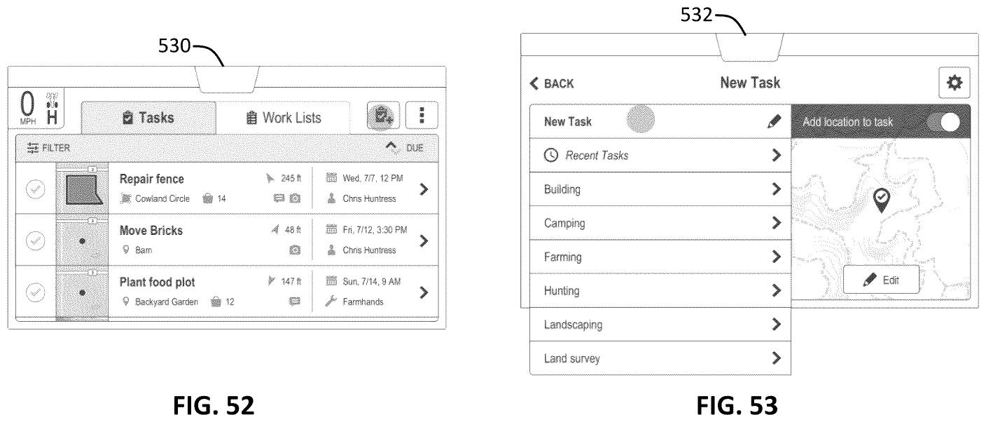

FIGS. 52-75 depict multiple GUIs adapted for use on, and displayed by, user interface 126 of vehicle 100.

Specifically, FIG. 52 depicts GUI 530 displaying a list of unfiltered tasks, each task displayed with task content.

FIG. 53 depicts a new task GUI 532 displaying a pop-up menu with a list of categories for creating a new task, as well as a map for adding a location to the new task.

FIG. 54 depicts GUI 534 displaying a fillable list of task content for the new task of FIG. 53.

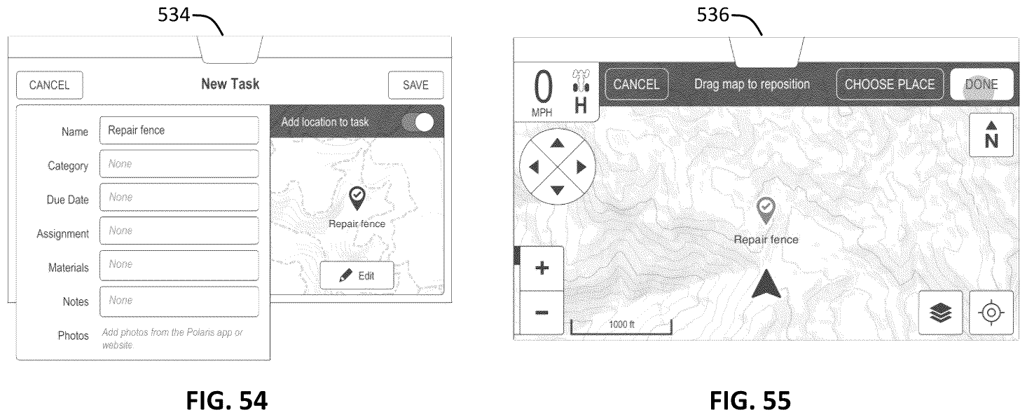

FIG. 55 depicts GUI 536 displaying a draggable map with a task indicator marking a location associated with a task, such as a “Repair fence” task. GUI 536 also depicts various graphical icons for map movement, to indicate direction, vehicle information, location selection, and so on.

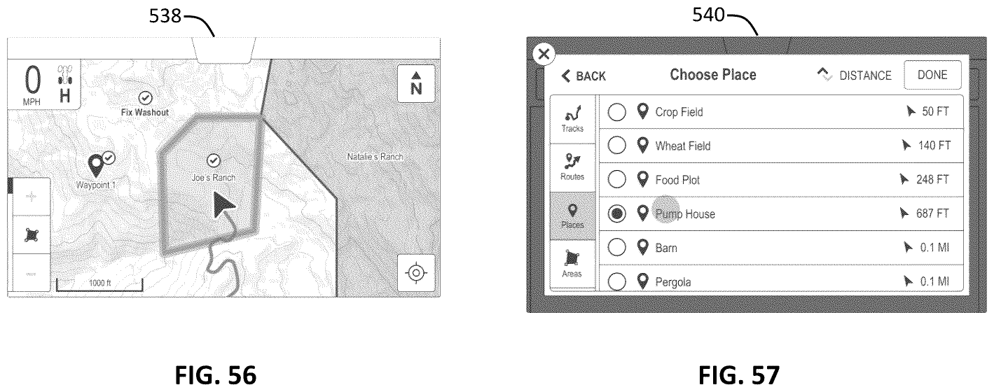

FIG. 56 depicts GUI 538 displaying a map with a first task having an associated location that is a geographical area, as well as a second task having an associated location corresponding to a waypoint and a third task having an associated location corresponding to a specific geographic point.

FIG. 57 depicts GUI 540 displaying a list of task locations that are named places, and distances from vehicle 100 to each listed location.

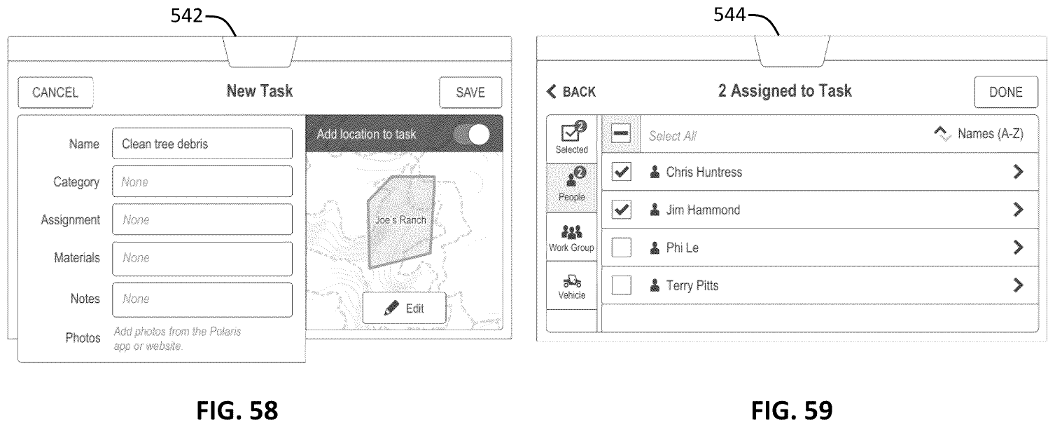

FIG. 58 depicts GUI 542 displaying a fillable list of task content for a new task, the location corresponding to a geographic area

FIG. 59 depicts GUI 544 displaying a list of people/users assigned to a particular task, as well as a list of potential users.

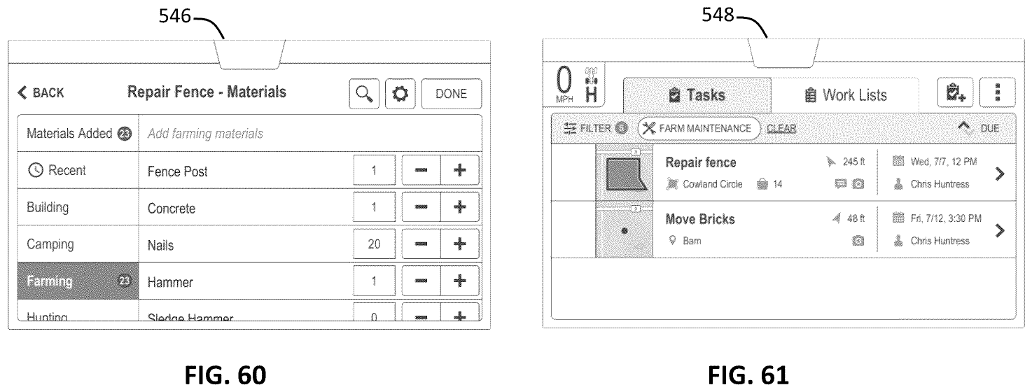

FIG. 60 depicts GUI 546 displaying a material list associated with a farming task. A materials quantity may be increased or decreased by a user tapping the plus or minus buttons, in the embodiment of a touch-screen user interface.

FIG. 61 depicts GUI 548 displaying a task list filtered by a category “Farm Maintenance.”

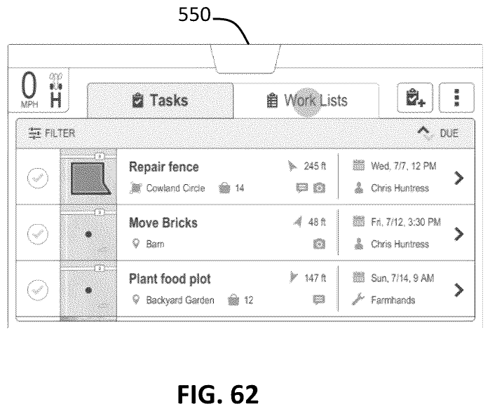

FIG. 62 depicts GUI 550 displaying an unfiltered task list, with each individual task forming a task row and including a completion indicator and task content, including task location, a location thumbnail, task name, task assignment, due date and more.

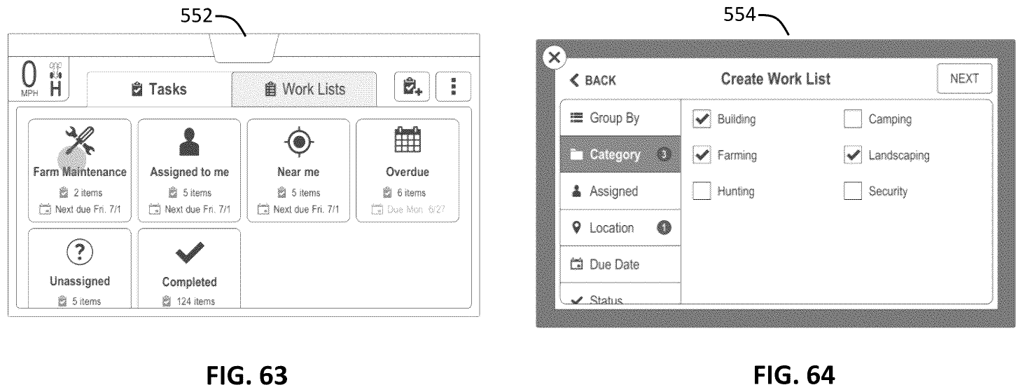

FIG. 63 depicts GUI 552 displaying a plurality of work list icons, each work list icon corresponding to a work list. GUI 552 also displays some work list details for each work list, such as number of items and due date.

FIG. 64 depicts GUI 554 for creating a work list based on categories.

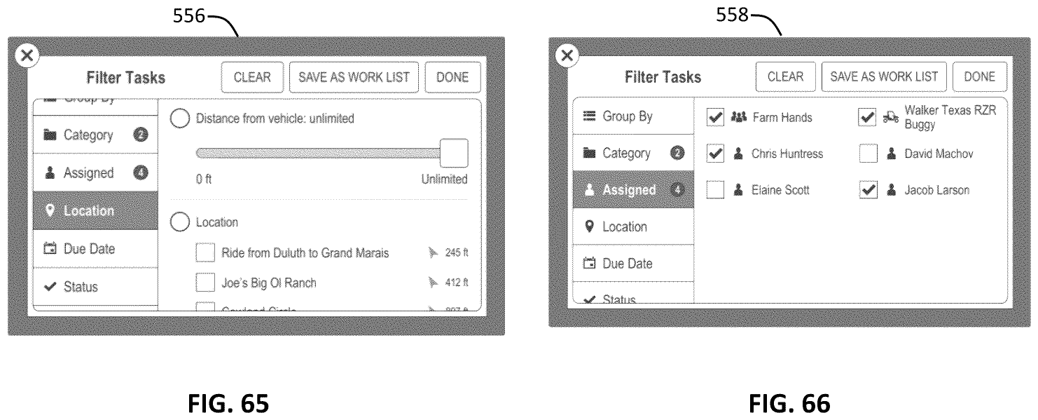

FIG. 65 depicts GUI 556 displaying available options for filtering tasks, such as by location, as depicted.

FIG. 66 depicts GUI 558 displaying available options for filtering tasks, such as by assignment, as depicted.

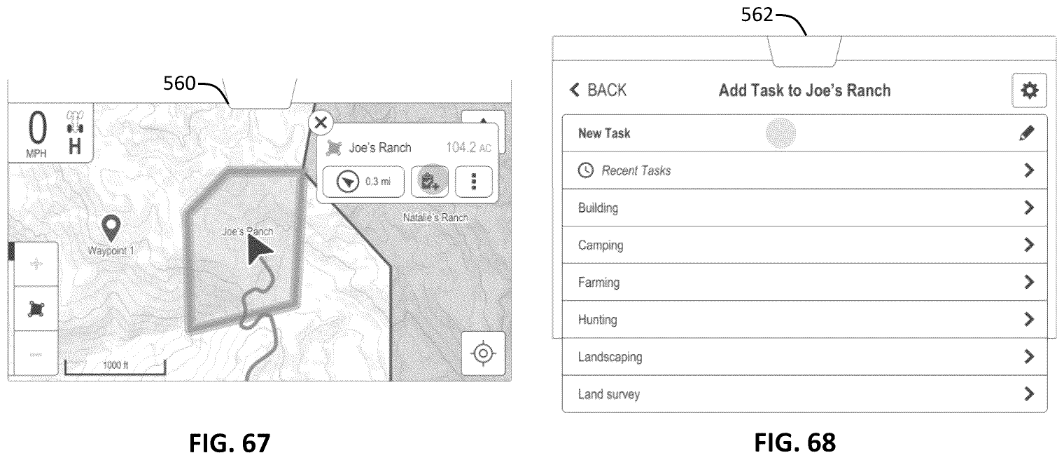

FIG. 67 depicts GUI 560 displaying a map associated with a location that is a place corresponding to a geographical area, as well as details about the place in an overlay GUI, and an add task graphical button/icon.

FIG. 68 depicts GUI 562 displaying a list of categories, as well as a recent task icon, one of which is to be selected to begin defining a new task corresponding to the category or recent task selected from the list. GUI 562 is displayed in response to a request to add a new task from the map, such as by selecting or tapping the add task button of GUI 560

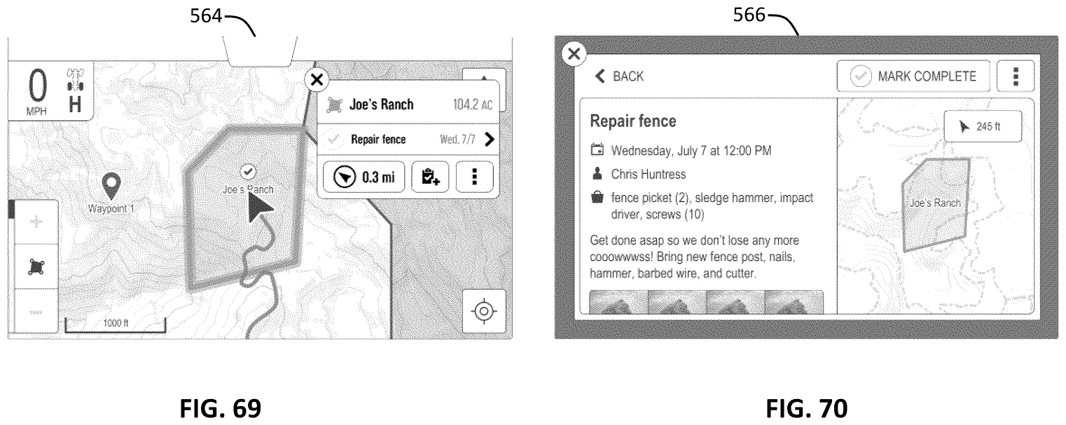

FIG. 69 depicts GUI 564 which is similar to GUI 560 of FIG. 67, but displaying a task name, task completion status (faint check mark), and due date.

FIG. 70 depicts GUI 566 displaying details of a selected task, “Repair fence,” which includes task content, as well as a map depicting the location of the task. In an embodiment, a task and corresponding map with location may be displayed in a split-screen format as depicted.

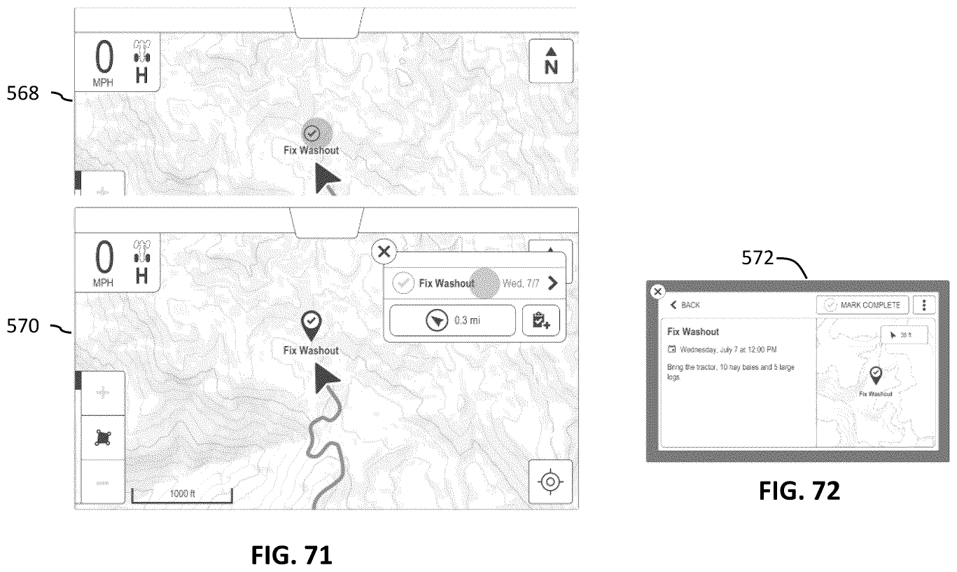

FIG. 71 depicts a portion of a GUI 568 of a location on a map, as well as GUI 570 which is displayed in response to the task displayed in GUI 568 being selected by a user. In GUI 570, an overlay of the task name with task content is displayed on the map. When the task name is selected from the overlay, in an embodiment, and as depicted in FIG. 72, GUI 572 is displayed with the task name and content, along with the map with location, in a split-screen format, similar to FIG. 70.

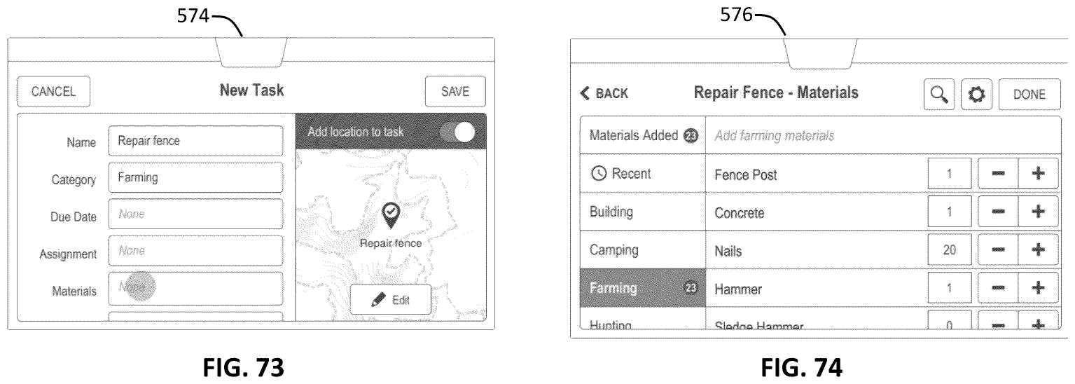

FIG. 73 depicts GUI 574 which displays a screen for creating a new task, with fillable areas for receiving user input relating to task content, such as task name, category, and so on, as well as a map indicating the task location. Selecting the displayed materials icon causes GUI 576 of FIG. 74 to be displayed. GUI 576 displays materials associated with the task category “Farming.”

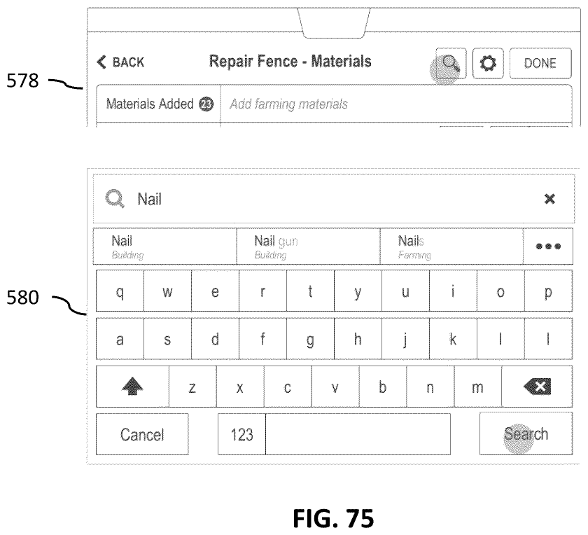

FIG. 75 depicts a portion of a GUI 578 displaying a search feature relating to the materials of a task (Repair Fence). Selecting a search icon causes search GUI 580 to be displayed. Search GUI 580 includes a graphical search box for receiving search terms input by a user, as well as a graphical keyboard.

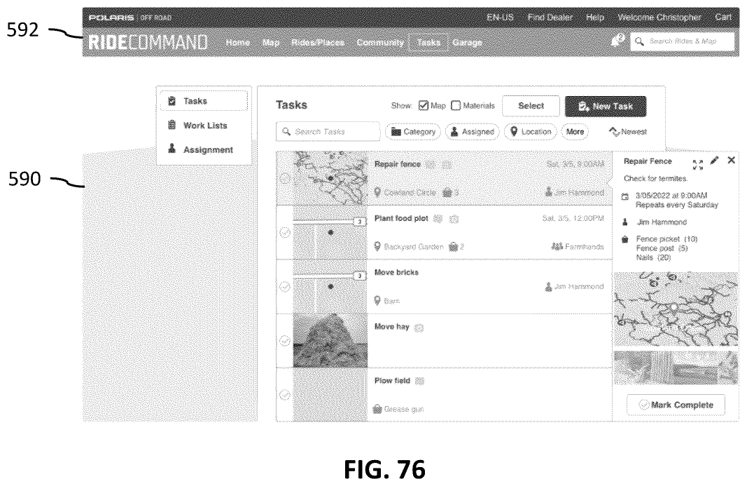

As described above, any and all of the features of location-based task management system m ay be implemented with any of the user interfaces of the system, including user interface 165 of remote computing device 164. In some embodiments, user interface 165 may display more of the available features in a single GUI, as compared to user interfaces 126 and 163, which may include smaller display screens. FIGS. 76-100 depict multiple GUIs adapted for use on, and displayed by, user interface 165 of remote computing device 164.

FIG. 76 depicts GUI 590 displaying a list of unfiltered tasks, each task displayed with task content. In an embodiment, user interface 165 may also display information and graphics related to a vehicle mapping system that may include location determination system 128, as evident by the displayed title bar 592 entitled “RIDE COMMAND,” which displays graphical buttons or tabs related to features other than the location-based task features described herein, such as home, map, rides/places, community and garage. In an embodiment, when a user selects the “Tasks” tab. GUI 590 displays the task list.

Also displayed by GUI 590 in the tasks tab are options to view tasks, work lists and assignment, as described in detail above with respect to user interface 163. In an embodiment, the task content displayed may be configurable by a user, such as map, materials, and so on. In such an embodiment, and as depicted in GUI 592, graphical boxes may be placed adjacent to various task content items to be selected for display. GUI 590 also displays a search tasks box for requesting system 160 to search the saved tasks based on data input by a user.

Filter buttons for filtering tasks by category, assignment, location and so on are also depicted.

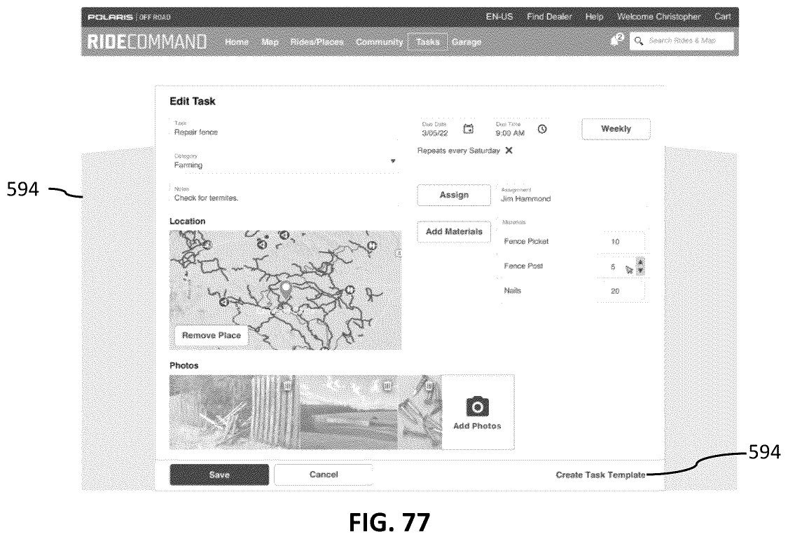

FIG. 77 depicts GUI 594 which may be used to edit a task, i.e., change the task content. In an embodiment, GUI 594 displays the task name, category notes, due date, assignment and materials, a map of the location, as well as any photos associated with the task may also be displayed. From GUI 594, a user may request that a task template be created via graphical “create task template” button 596.

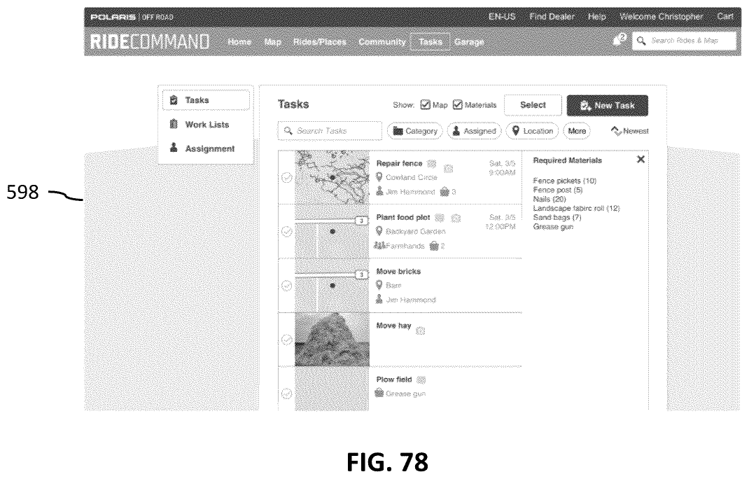

FIG. 78 depicts GUI 598 displaying a task list, each displayed task also including some task content. In this embodiment, maps depicting locations associated with each task are selected by a user for display, as are materials.

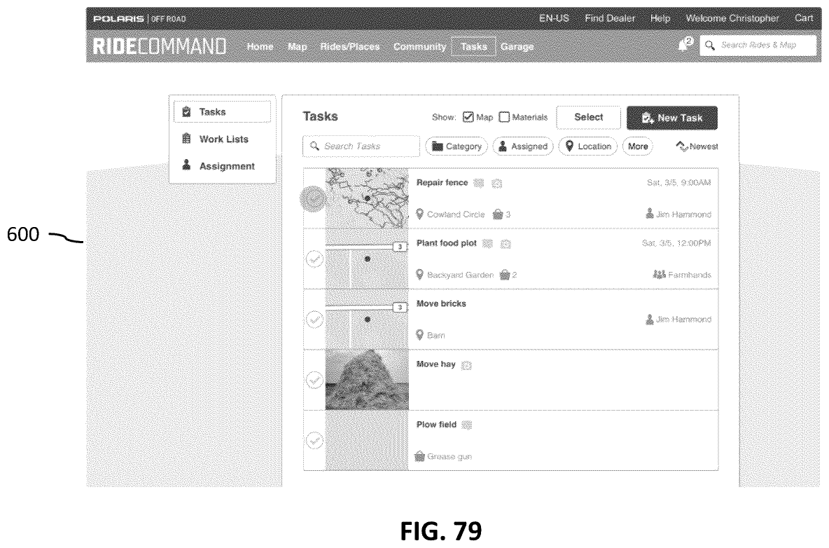

FIG. 79 depicts GUI 600 displaying a task list, with a first task being selected for completion.

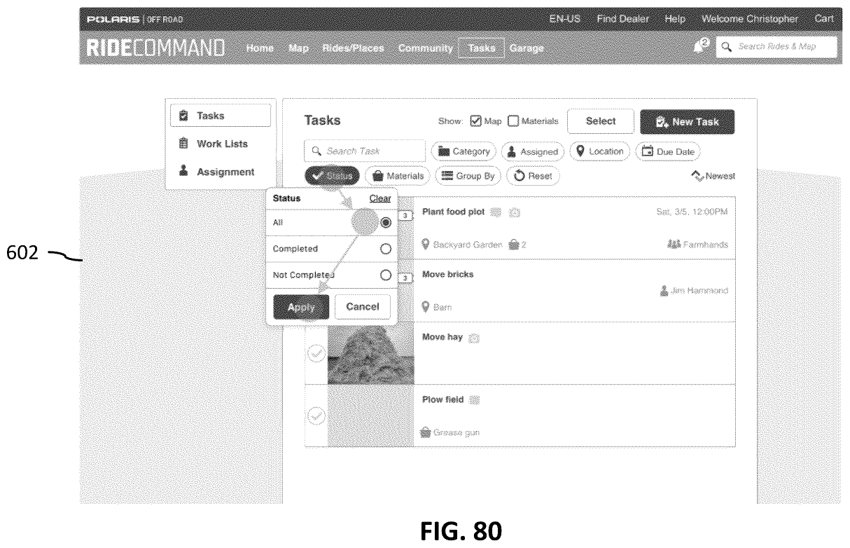

FIG. 80 depicts GUI 602 displaying a task list, and also a pop-up menu resulting from a “status” filter request being made by a user. In an embodiment, when the status button is selected, a pop-up menu appears, and tasks can be filtered by status, such as not completed, completed or all.

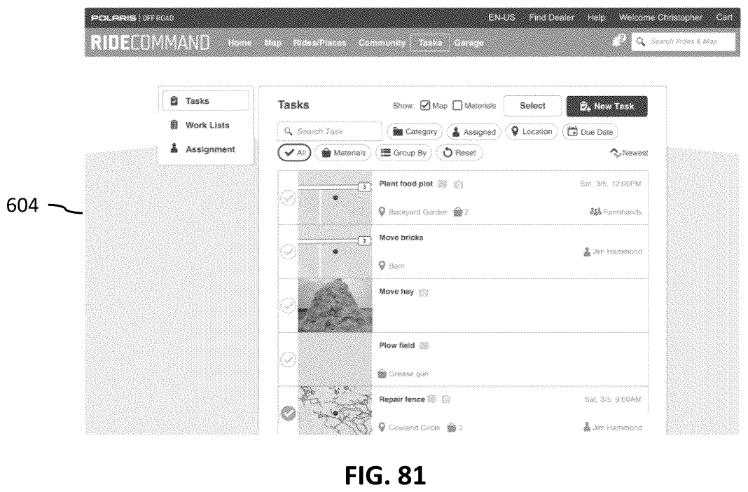

FIG. 81 depicts GUI 604 displaying a solid circle and check mark next to one task (“Repair fence”) in the displayed task list, thereby indicating that the indicated task is complete.

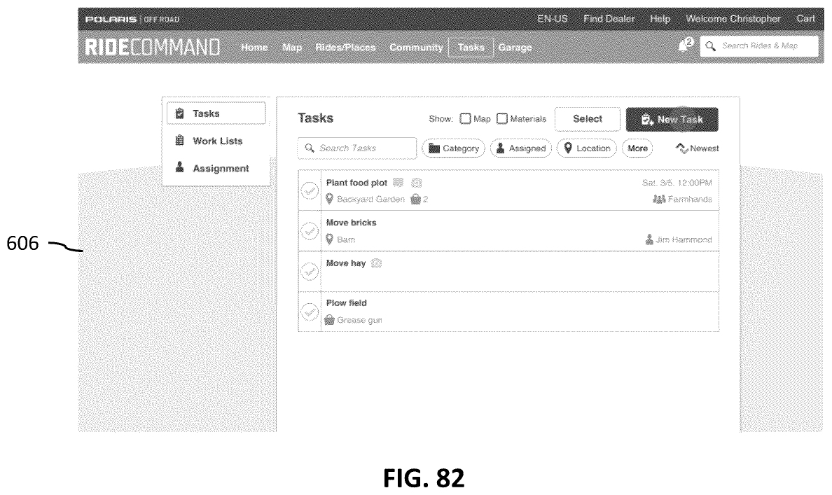

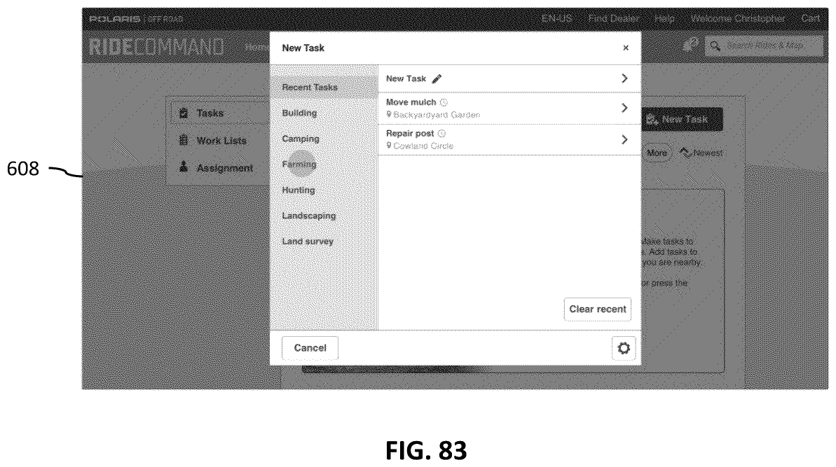

FIG. 82 depicts GUI 606 displaying another embodiment of a task list. In this embodiment, map and materials associated with the tasks are not displayed. Selection of the new-task button causes GUI 608 of FIG. 83 to be displayed. GUI 608 displays a list of selectable task categories for creating a new task. In the depicted embodiment, recent tasks are displayed as part of GUI 608.

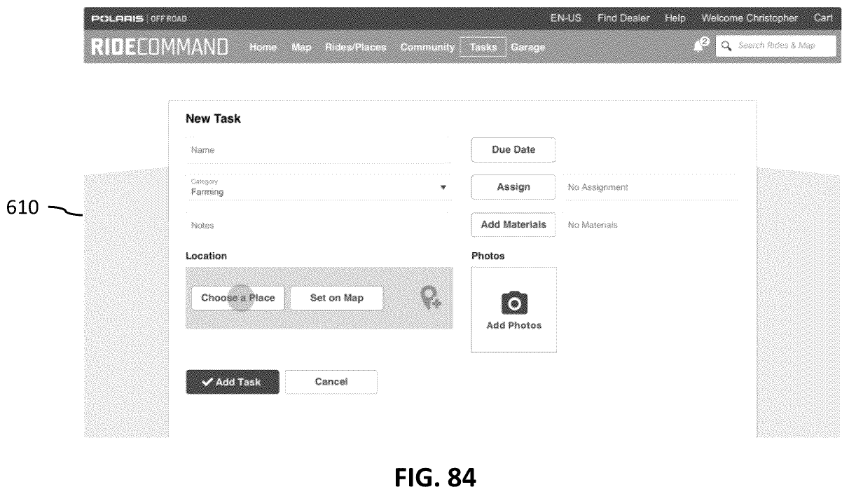

FIG. 84 depicts GUI 610 displaying options for defining a new task.

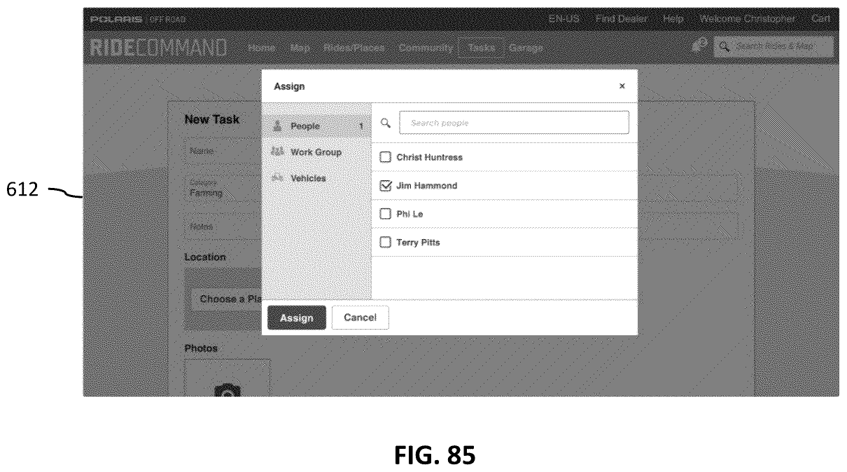

FIG. 85 depicts GUI 612 for assigning a new task to a person selected from a displayed list.

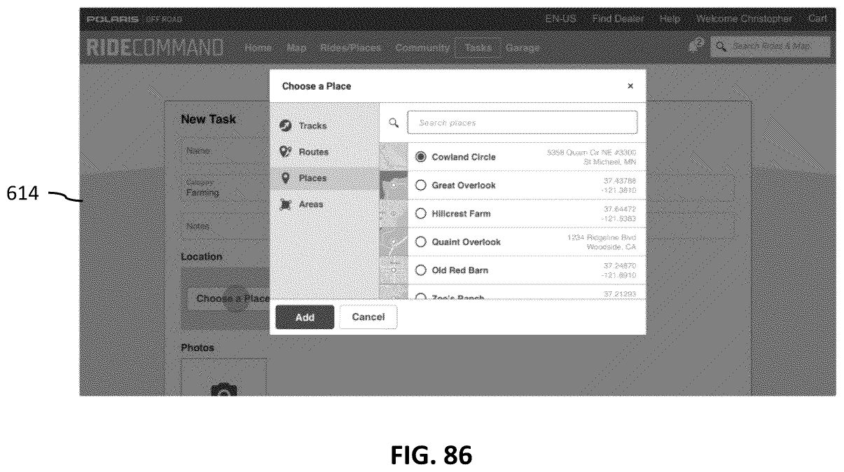

FIG. 86 depicts GUI 614 for associating a location with a task. In the depicted embodiment, a location that is a place has been selected from the group of location types that include tracks, routes, places and areas. A list of places is displayed.

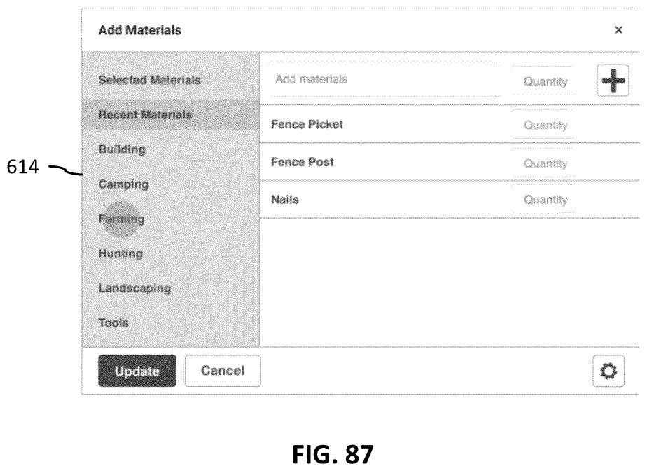

FIG. 87 depicts GUI 616 for adding materials to a task. In this embodiment, a “farming” category has been selected from a list of available task categories, such that materials associated with the farming category is displayed. As described above, system 160 is configured to display graphical features on a user interface, and to receive input from a user regarding quantities of materials. Such graphical features are depicted in GUI 614 of FIG. 87.

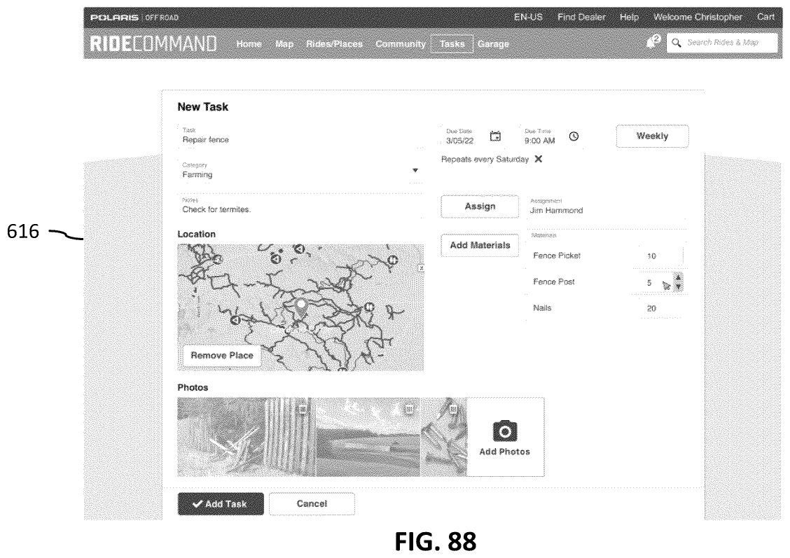

FIG. 88 depicts GUI 616 displaying graphics for adding a new task.

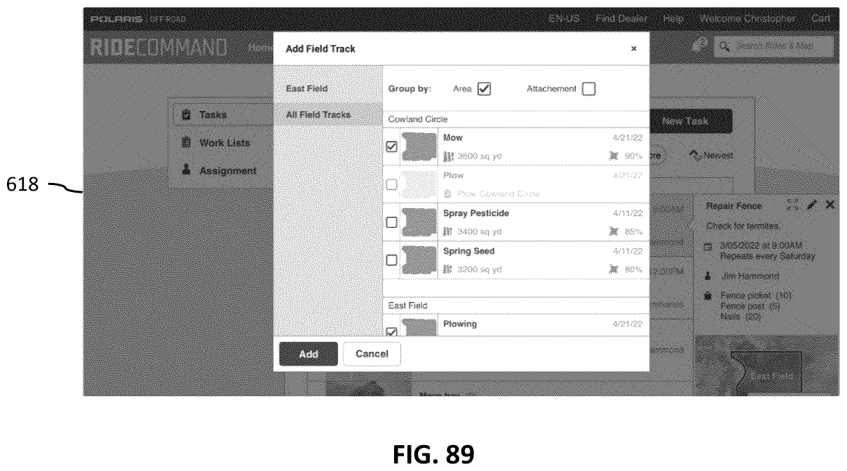

FIG. 89 depicts GUI 618 displaying options for adding a location that is a field track. In this embodiment, saved field tracks are displayed in list form, and selectable by a user. Categories of field tracks are selected by interacting with field track category buttons that may refer to a particular location or area, such as the “East Field” track depicted in GI 618.

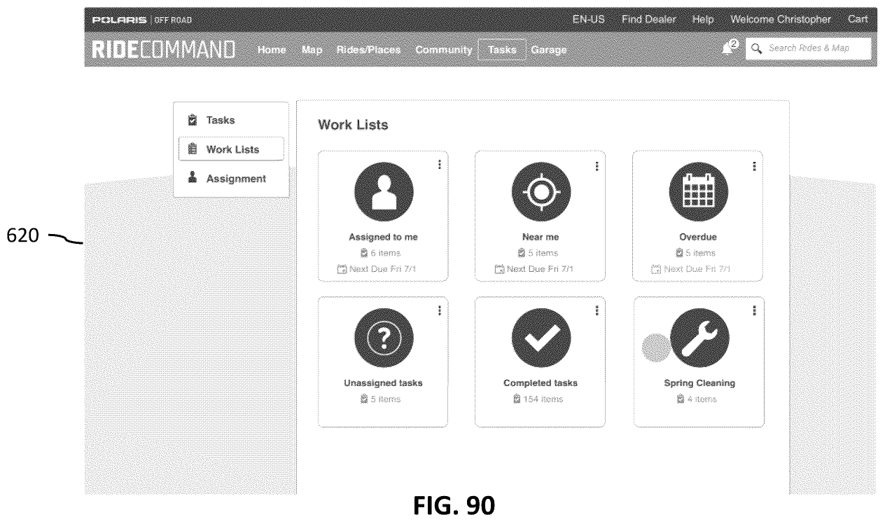

FIG. 90 depicts GUI 620 displaying work lists. In this embodiment, available work lists are displayed as selectable icons. As also described above, available work lists may include lists of task assigned to a user, tasks near a user, overdue tasks, unassigned tasks, completed tasks and so on.

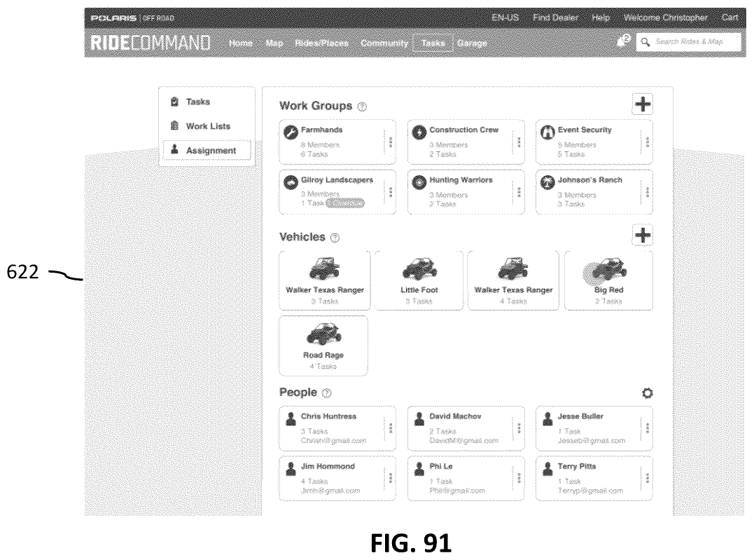

FIG. 91 depicts GUI 622 displaying assignments by work groups, vehicles and people.

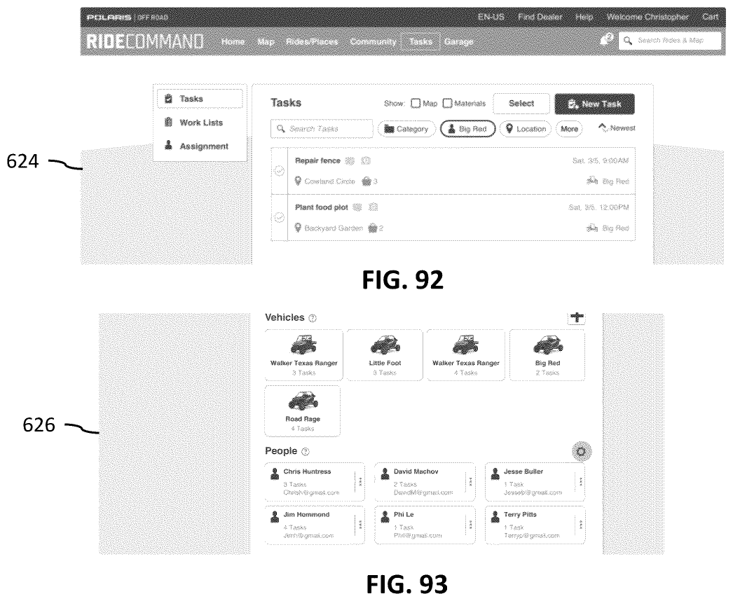

FIG. 92 depicts GUI 624 displaying a filtered list of tasks. In this embodiment, the tasks are filtered by a particular vehicle, “Big Red.” Referring also to FIG. 93, GUI 626 displays a list or set of icons of vehicles 100 and people. Tasks may be filtered by category, location, people, and in this case, by vehicle.

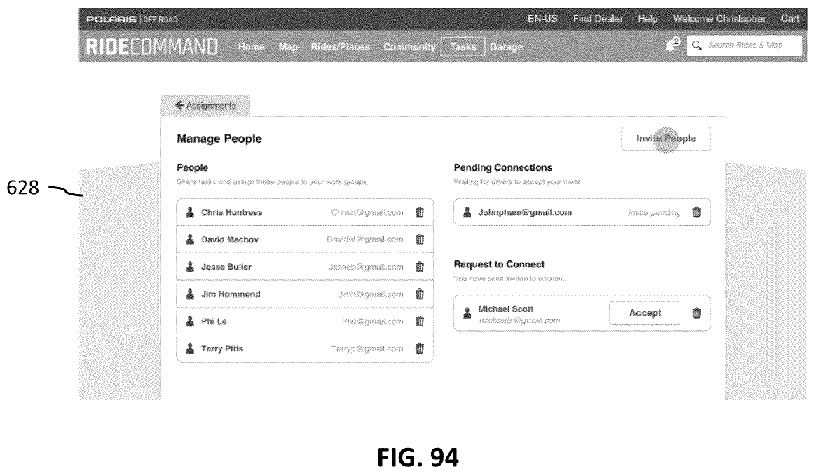

FIG. 94 depicts GUI 628 for managing people. Methods for managing people and users is described with respect to corresponding user interface 163 above.

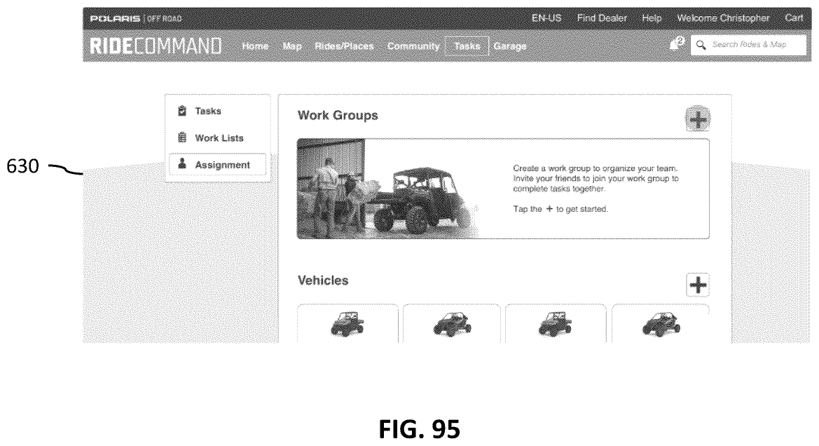

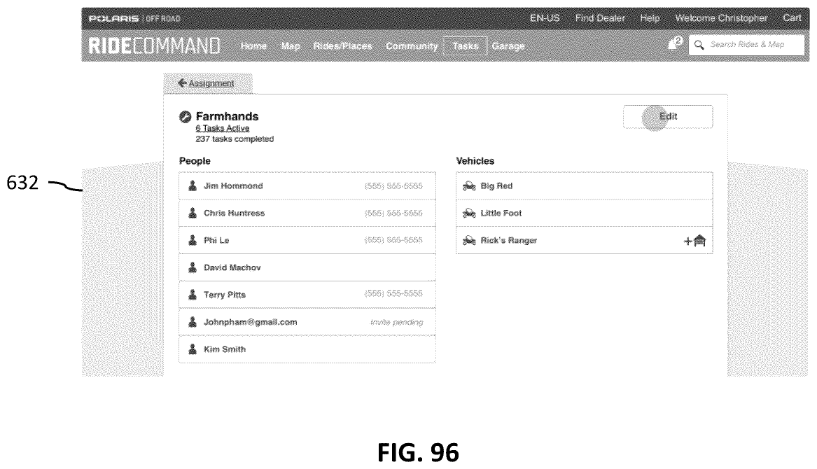

FIG. 95 depicts GUI 630 displaying an explanation of work group formation for a user, as part of the assignment functionality.

FIG. 96 depicts assignment GUI 632 that displays lists of people and vehicles associated with a selected work group, e.g., “Farmhands.”

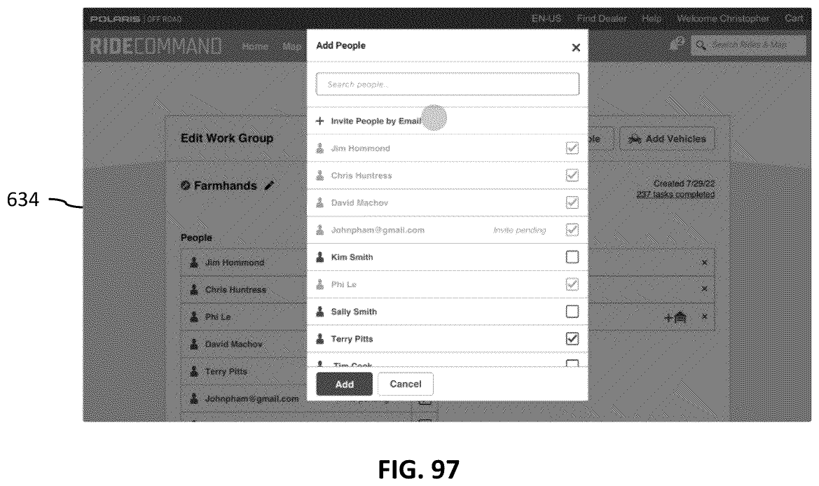

FIG. 97 depicts GUI 634 displaying an add-people function for adding a person or user to a work group. Work groups may be edited to add or remove persons/users, vehicles.

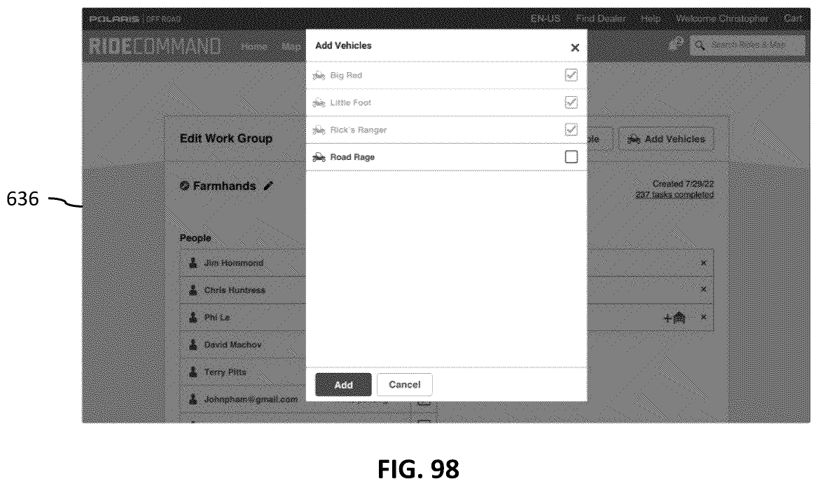

FIG. 98 depicts GUI 636 displaying an add-vehicle function for adding a vehicle to a work group.

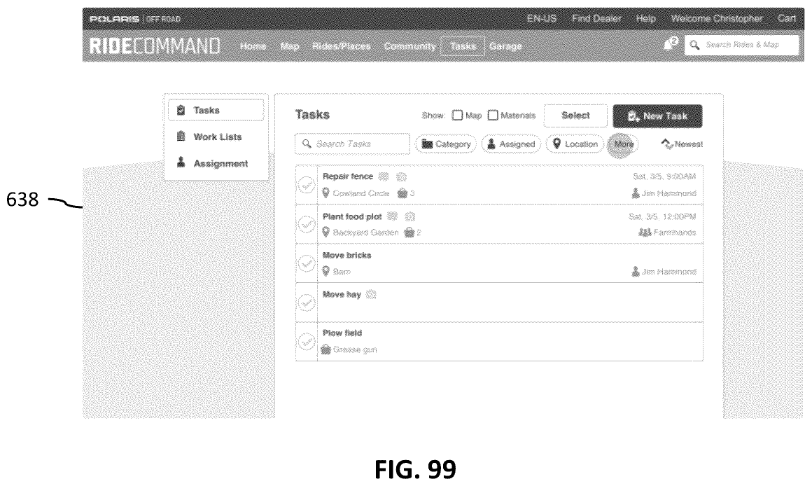

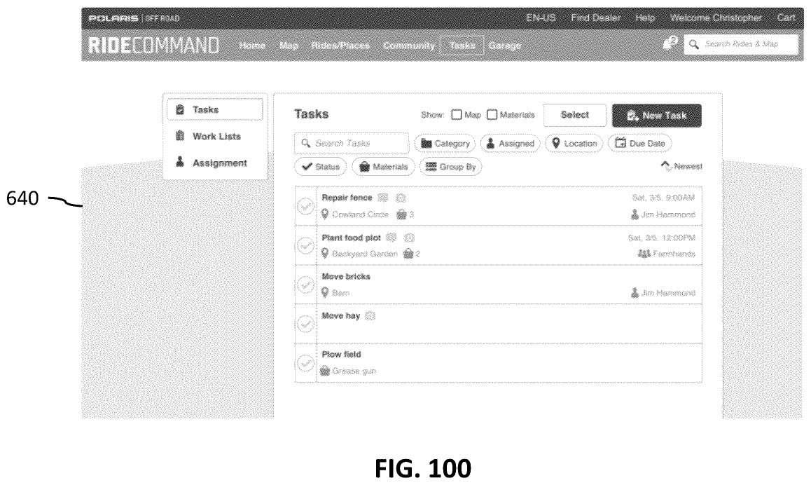

FIG. 99 depicts GUI 638 displaying a list of tasks with a plurality of filter buttons, including a “more” filter button that upon selection by a user causes GUI 640 of FIG. 100 to be displayed. GUI 640 displays additional filters, such as due date, status, materials and “group by.”

The following clauses illustrate the subject matter described herein.

Clause 1. A method for managing location-based tasks for a location-aware vehicle, including: receiving a first request from a first device having a first user interface to create a first location-based task; creating a first location-based task based on the input received from the first device; storing the first location-based task in a task-service memory; associating the first location-based task with a first location; and associating the location-based task with the location-aware vehicle.

Clause 2. The method of clause 1, wherein receiving a request from a first device having a user interface to create a first location-based task includes receiving a request from a user interface device integrated into the location-aware vehicle.

Clause 3. The method of clause 1, wherein receiving a request from a first device having a first user interface to create a first location-based task includes receiving a request a from a handheld remote device over a local wireless network.

Clause 4. The method of clause 1, wherein receiving a request from a first device having a user interface to create a first location-based task includes receiving a request from a remote computing device over a wide-area network.

Clause 5. The method of clause 1, wherein creating a first location-based task based on the input received from the first device includes associating task content with the first location-based task.

Clause 6. The method of clause 5, wherein the task content includes one or more of a task location, task name, task category, task date, task assignment, materials associated with the first task, user notes and photos.

Clause 7. The method of clause 1, wherein storing the first location-based task in a task-service memory comprises storing the first location-based task in a task-service memory integrated into the location-aware vehicle or storing the first location-based task in a task-service memory located remote to the location-aware vehicle.

Clause 8. The method of clause 1, wherein associating the first location-based task with a first location includes receiving an input at the first user interface indicating a location on a graphical map displayed on the first user interface.

Clause 9. The method of clause 1, wherein associating the first location-based task with a first location includes identifying a current location of the location-aware vehicle and associating the current location of the location-aware vehicle with the first location.

Clause 10. The method of clause 1, wherein associating the first location-based task with a first location includes receiving an input at the first user interface selecting a predetermined location saved in a memory device in communication with the first device.

Clause 11. The method of clause 10, wherein the predetermined location includes a saved track, route, or geographical area.

Clause 12. The method of clause 1, wherein associating the location-based task with the location-aware vehicle includes assigning the first location-based task to the location aware-vehicle.

Clause 13. The method of clause 1, further including: receiving a second request from a second device having a second user interface to create a second location-based task; creating a location-based second task based on the input received from the second device; and storing the second location-based task in the task-service memory; and creating a set of location-based tasks that includes the first location-based task and the second location-based task.

Clause 14. The method of clause 13, further comprising associating the second location-based task with a second location-aware vehicle.

Clause 15. The method of clause 13, further comprising displaying the set of location-based tasks as a task list on a display screen of the first user interface of the first device or on a display screen of the second user interface of the second device.

Clause 16. The method of clause 13, further comprising filtering the set of location-based tasks to create a work list includes less than all of the location-based tasks of the set of location-based tasks.

Clause 17. The method of clause 15, wherein filtering the set of location-based tasks includes filtering the set of location-based tasks based on one or more of the following parameters: location-based tasks assigned to a specific user, location-based tasks associated with a location that is within a predetermined distance of the specific user, location-based tasks associated with a location that is within a predetermined distance of the location-aware vehicle, overdue location-based tasks having an associated due date that is prior to a current due date, location-based tasks that are not assigned to a user or a location-aware vehicle, and location-based tasks that are not completed.

Clause 18. The method of clause 1, further comprising displaying the first location associated with the first location-based task on a graphical map displayed on the first user interface.

Clause 19. The method of clause 1, further comprising identifying materials required for the first location-based task and associating the identified materials with the first location-based task.

Clause 20. The method of clause 18, further comprising creating and displaying a list of materials required for the first location-based task and a second location-based task.

Clause 21. The method of clause 1, further comprising creating a location-based task template.

Clause 22. The method of clause 1, further comprising receiving another input from the first device requesting that the first location-based task be defined as a completed location-based task.

Clause 23. A method of creating a location-based task for a location-aware vehicle, including: receiving a request from a device having a user interface to create a location-based task; identifying the task location of the location-based task for the location-aware vehicle; determining task content of the location-based task, including the task location and one or more of a task name, task category, task materials, task work group, vehicle operator, and vehicle identification; and assigning the location-based task to the location-aware vehicle.

Clause 24. The method of clause 23, wherein identifying the task location of the location-based task for the location-aware vehicle includes identifying the task location using a geolocation system of the location-aware vehicle.

Clause 25. The method of clause 23, wherein identifying the task location of the location-based task for the location-aware vehicle includes receiving an output signal from the device, the device including a touch-screen display user-interface displaying a graphical map, and the output signal including an indication of a location defined on the graphical map based on an input received from a user touching the touch-screen display.

Clause 26. The method of clause 23, further comprising communicating the location-based task and task content to the location-aware vehicle.

Clause 27. A method of creating a work list from a plurality of location-based tasks, including: defining a plurality of location-based tasks, each location-based task associated with a predefined location and including predefined task content, including one or more task content items of a task name, task location, task category, task materials, task workgroup, vehicle operator, and vehicle identification; displaying all or a portion of the plurality of location-based tasks on a display of a user interface of a location-aware vehicle or a remote computing device; displaying a list of available task filters on the display of the user interface; transmitting a request from the user interface to a task-service processor identifying selection of the task filters; and defining a work list using the task-service processor, the work list including less than all of the defined plurality of location-based tasks based on the selection of the task filters.

Clause 28. The method of clause 27, wherein one or more of the available task filters corresponds to a task content of the location-based task.

Clause 29. The method of clause 27, wherein one or more of the available task filters corresponds to tasks assigned to an operator of the location-based vehicle, tasks in a predetermined vicinity of the operator or the location-based vehicle, tasks that are not assigned to an operator or vehicle, tasks that are past due, or tasks that are defined as completed.

Clause 30. A method of managing a plurality of location-based tasks for a plurality of location-aware vehicles, including: defining the plurality of location-based tasks, including a first task having first task content and a second task having second task content; associating each of the plurality of location-based tasks with a task location, including associating the first location-based task with a first task location, and associating a second location-based task with a second task location; identifying the plurality of location-aware vehicles, including identifying a first location-aware vehicle and a second location-aware vehicle, the first location-aware vehicle configured to determine a vehicle location of the first location-aware vehicle and the second location-aware vehicle configured to determine a vehicle location of the second location-aware vehicle; communicating a first location-based task to the first location-aware vehicle; and communicating a second location-based task to the second location-aware vehicle.

Clause 31. A method, including: defining a plurality of location-based tasks, including a first set of tasks and a second set of tasks; associating the plurality of location-based tasks with a plurality of unique locations, including associating a first set of location-based tasks with a first set of unique locations and associating a second set of task with a second set of unique locations; communicating the plurality of tasks and associated unique locations to a location-aware vehicle; displaying a graphical map of a location area that includes a first location of the location-aware vehicle, graphical representations of the first set of location-based tasks, and the first set of associated unique locations; and changing a display of the graphical map to display a second location of the location-aware vehicle, graphical indicators of the second set of tasks and the second set of associated unique locations, in response to the location-aware vehicle moving from the first location to the second location.

Clause 32. An off-road utility vehicle for managing location-based tasks, including: a vehicle frame connected to a plurality of ground-engaging members; a vehicle prime mover coupled to the vehicle frame; a vehicle controller including configured to control vehicle operating systems, including the vehicle prime mover; a geolocation system in communication with the vehicle controller and configured to determine a location of the off-road utility vehicle; a network interface in communication with the vehicle controller and configured to communicate to remote computing devices; a user interface in communication with the vehicle controller, the user interface including a display device, and an input device configured to receive data relating to the location-based task, including a location of the location-based task; and a task-service processor configured to communicate with the vehicle controller, the task-service processor configured to: receive the location of the off-road utility vehicle from the geolocation system, receive the data relating to the location-based task, and manage the location-based tasks based on the location of the off-road utility vehicle, and the data relating to the location-based task, including creating a location-based task list to be displayed on the display device of the user interface.

As described in detail above, and as depicted in the various figures, embodiments of the present disclosure include many methods, systems and devices convenient for efficiently managing location-based task associated with location-aware vehicles.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A method for managing location-based tasks for a location-aware vehicle, comprising:
receiving a first request from a first device having a first user interface to create a first location-based task;
creating a first location-based task based on the input received from the first device;
storing the first location-based task in a task-service memory;
associating the first location-based task with a first location; and
associating the location-based task with the location-aware vehicle.

2. The method of claim 1, wherein receiving a request from a first device having a user interface to create a first location-based task includes receiving a request from a user interface device integrated into the location-aware vehicle.

3. The method of claim 1, wherein creating a first location-based task based on the input received from the first device includes associating task content with the first location-based task.

4. The method of claim 3, wherein the task content includes one or more of a task location, task name, task category, task date, task assignment, materials associated with the first task, user notes and photos.

5. The method of claim 1, wherein associating the first location-based task with a first location includes receiving an input at the first user interface indicating a location on a graphical map displayed on the first user interface.

6. The method of claim 1, wherein associating the first location-based task with a first location includes identifying a current location of the location-aware vehicle and associating the current location of the location-aware vehicle with the first location.

7. The method of claim 1, wherein associating the first location-based task with a first location includes receiving an input at the first user interface selecting a predetermined location saved in a memory device in communication with the first device.

8. The method of claim 7, wherein the predetermined location includes a saved track, route, or geographical area.

9. The method of claim 1, further comprising:
receiving a second request from a second device having a second user interface to create a second location-based task;
creating a location-based second task based on the input received from the second device; and
storing the second location-based task in the task-service memory; and
creating a set of location-based tasks that includes the first location-based task and the second location-based task.

10. The method of claim 9, further comprising associating the second location-based task with a second location-aware vehicle.

11. The method of claim 9, further comprising displaying the set of location-based tasks as a task list on a display screen of the first user interface of the first device or on a display screen of the second user interface of the second device.

12. The method of claim 9, further comprising filtering the set of location-based tasks to create a work list includes less than all of the location-based tasks of the set of location-based tasks.

13. The method of claim 1, further comprising displaying the first location associated with the first location-based task on a graphical map displayed on the first user interface.

14. The method of claim 1, further comprising identifying materials required for the first location-based task and associating the identified materials with the first location-based task.

15. A method of creating a location-based task for a location-aware vehicle, comprising:
receiving a request from a device having a user interface to create a location-based task;
identifying the task location of the location-based task for the location-aware vehicle;
determining task content of the location-based task, including the task location and one or more of a task name, task category, task materials, task work group, vehicle operator, and vehicle identification; and
assigning the location-based task to the location-aware vehicle.

16. The method of claim 15, wherein identifying the task location of the location-based task for the location-aware vehicle includes identifying the task location using a geolocation system of the location-aware vehicle.

17. The method of claim 15, wherein identifying the task location of the location-based task for the location-aware vehicle includes receiving an output signal from the device, the device including a touch-screen display user-interface displaying a graphical map, and the output signal including an indication of a location defined on the graphical map based on an input received from a user touching the touch-screen display.

18. The method of claim 15, further comprising communicating the location-based task and task content to the location-aware vehicle.

19. A method of managing a plurality of location-based tasks for a plurality of location-aware vehicles, comprising:
defining the plurality of location-based tasks, including a first task having first task content and a second task having second task content;
associating each of the plurality of location-based tasks with a task location, including associating the first location-based task with a first task location, and associating a second location-based task with a second task location;
identifying the plurality of location-aware vehicles, including identifying a first location-aware vehicle and a second location-aware vehicle, the first location-aware vehicle configured to determine a vehicle location of the first location-aware vehicle and the second location-aware vehicle configured to determine a vehicle location of the second location-aware vehicle;
communicating a first location-based task to the first location-aware vehicle; and
communicating a second location-based task to the second location-aware vehicle.

20. The method of claim 19, wherein the first task location is different from the second task location and the first location-based task is different from the second location-base task.
